(19) United States
(12) Patent Application Publication
(10) Pub. No.: US 2019/0176191 A1
(43) Pub. Date: Jun. 13, 2019

(54) SYSTEM AND METHODS FOR FORMING A SELF-ADHESIVE FIBROUS MEDIUM

(71) Applicant: 4C Air, Inc., Sunnyvale, CA (US)

(72) Inventors: Qiqi Wang, Santa Clara, CA (US); Lei Liao, Sunnyvale, CA (US); Lisha Bai, Sunnyvale, CA (US); Qiu Yang, Sunnyvale, CA (US); Yi Cui, Stanford, CA (US)

(21) Appl. No.: 16/212,345

(22) Filed: Dec. 6, 2018

Related U.S. Application Data
(60) Provisional application No. 62/596,055, filed on Dec. 7, 2017.

(51) Int. Cl. B05D 5/10; D01D 5/00; B05D 1/06; B05B 5/025

(52) U.S. Cl. CPC B05D 5/10; B05B 5/025; B05D 1/06; D01D 5/0069

(57) ABSTRACT

Disclosed herein are systems, devices, and method for forming self-adhesive single or multilayer fibrous media.

### CROSS REFERENCE TO RELATED APPLICATIONS

This application claims the benefit under 35 U.S.C. § 119(e) of the U.S. Provisional Application Ser. No. 62/596,055 filed Dec. 7, 2017, the content of which is hereby incorporated by reference in its entirety.

### BACKGROUND

Fibrous media, e.g., comprising polymer fibers, are used in a variety of diverse applications, such as medical and protective garments, insulation, filters, ceiling tiles, battery separator media, tissue engineering scaffolds, etc. In some applications, there is a need to glue fibrous media. However, conventional gluing systems, e.g., roller gluing systems and gun gluing systems, are associated with several disadvantages. For instance, such conventional gluing systems cannot provide fine fiber-like glue spots and thus have insufficient adhesive contact points (in the case of insufficient glue usage), or are often plagued with waste and disposal issues due to use of excessive adhesive, or problems associated with uniformity of coverage, etc.

There is thus a need in the art for improved systems and methods for gluing fibrous media, and which avoid the aforementioned disadvantages.

### SUMMARY

The present disclosure provides unique and customizable systems, devices, and methods for the fabrication of self-adhesive fibrous media.

Accordingly, in one embodiment, provided herein is a method of forming a self-adhesive, dual or multilayer fibrous medium, the method comprising forming at least two vertically arranged layers on a substrate, where a first of the layers comprises a first plurality of fibers, and a second of the layers comprises a second plurality of adhesive fibers. In some embodiments, the second plurality of adhesive fibers is formed via electrospraying. In some embodiments, a basis weight of the second plurality of adhesive fibers is about equal to or less than a basis weight of the first plurality of fibers.

In some embodiments, the basis weight of the second plurality of adhesive fibers is less than the basis weight of the first plurality of fibers. In some embodiments, the basis weight of the second plurality of adhesive fibers is about equal to the basis weight of the first plurality of fibers. In some embodiments, the basis weight of the second plurality of adhesive fibers is greater than the basis weight of the first plurality of fibers.

In some embodiments, the basis weight of the second plurality of adhesive fibers is in a range from about 0.1 g/m² to about 10 g/m². In some embodiments, the basis weight of the first plurality of fibers is in a range from about 1 g/m² to about 1000 g/m².

In some embodiments, an average diameter of the second plurality of adhesive fibers is about equal to or less than an average diameter of the first plurality of fibers. In some embodiments, an average diameter of the second plurality of adhesive fibers is greater than an average diameter of the first plurality of fibers.

In some embodiments, each of the second plurality of adhesive fibers independently comprises a diameter in a range from about 10 nm to about 10 μm. In some embodiments, each of the first plurality of fibers independently comprises a diameter in a range from about 10 nm to about 100 μm.

In some embodiments, the first layer is formed directly on the substrate. In some embodiments, at least a third layer is further formed on the second layer such that the second layer is positioned between the first and third layers, wherein the third layer comprises a non-woven structure, a mesh structure, a woven structure, or a membrane.

In some embodiments, at least a third layer is formed directly on the substrate such that the second layer is positioned between the third and first layers, wherein the third layer comprises a non-woven structure, a mesh structure, a woven structure, or a membrane.

In some embodiments, the first layer is formed via a spunbonding process, a melt-blown process, an air-laid process, a wet-laid process, an electro-spinning process, spun-lacing (or hydroentangling) process, needle-punching process, or any combination thereof. In some embodiments, the first layer is formed via a spunbonding process, a melt-blown process, an electro-spinning process, or combinations thereof. In some embodiments, the first layer is formed via an air-laid process, a wet-laid process, a spun-lacing (or hydroentangling) process, a needle-punching process, or combinations thereof.

In some embodiments, each of the second plurality of adhesive fibers independently comprises a pressure sensitive adhesive polymer, a light sensitive adhesive polymer, a hot-melt adhesive polymer, or any combination thereof.

In some embodiments, each of the second plurality of adhesive fibers independently comprises an adhesive polymer material or a composition thereof, wherein the adhesive polymer material is selected from ethylene-vinyl acetate (EVA), polyolefins (PO), polyamides (PA), polyester, polyurethane (PU), an acrylic, bio-based acrylate, butyl rubber, nitriles, silicone rubber, styrene butadiene rubber, natural rubber latex, and combinations thereof.

In some embodiments, one or more of the second plurality of adhesive fibers are dual component adhesive fibers comprising two different polymer materials, provided one of the polymer materials is adhesive. In some embodiments, each of the dual component adhesive fibers comprises an outer region substantially surrounding one or more inner regions, wherein the outer region comprises a first adhesive polymer material, and the one or more inner regions independently comprise a second adhesive polymer material or a non-adhesive polymer material.

In some embodiments, one or more of the second plurality of adhesive fibers are multi-component adhesive fibers comprising at least three different polymer materials, provided one of the polymer materials is adhesive. In some embodiments, each of the multi-component adhesive fibers comprises an outer region substantially surrounding one or more inner regions, wherein the outer region comprises a first adhesive polymer material, and each of the one or more inner regions comprises at least two polymer materials independently selected from a second adhesive polymer material and a non-adhesive polymer material.

In some embodiments, at least a portion of the second plurality of adhesive fibers are not substantially aligned in a parallel alignment.

Also provided herein, in one embodiment, is a method of forming a self-adhesive, single layer fibrous medium, the method comprising: electrospraying, on a substrate, a single layer comprising an adhesive web, where the adhesive web comprises a plurality of dual or multi-component adhesive fibers, each dual component adhesive fiber comprising two different polymer materials, and each multi-component adhesive fiber independently comprising at least three different polymer materials, provided that at least one polymer material in the dual or multi-component fiber is adhesive in the outer layer part of the cross-section of the respective fiber.

In some embodiments, the adhesive web has a basis weight in a range from about 0.1 g/m² to about 1000 g/m².

In some embodiments, each dual or multi-component adhesive fiber independently comprises a diameter in a range from about 10 nm to about 10 μm.

In some embodiments, a non-woven structure, a mesh structure, a woven structure, or a membrane is further formed on the first layer.

In some embodiments, each dual component adhesive fiber comprises an outer region substantially surrounding one or more inner regions, wherein the outer region comprises a first adhesive polymer material, and each of the one or more inner regions comprises a second adhesive polymer material or a non-adhesive polymer material.

In some embodiments, each multi-component adhesive fiber comprises an outer region substantially surrounding one or more inner regions, wherein the outer region comprises a first adhesive polymer material, and each of the one or more inner regions comprises at least two polymer materials independently selected from a second adhesive polymer material and a non-adhesive polymer material.

Further provided herein, in one embodiment, is an electrospray system for forming a self-adhesive fibrous medium, the system comprising: a substrate, and at least one extrusion element in spaced relation with the substrate, the at least one extrusion element configured to deliver a first material and a second, adhesive material. The substrate and the at least one extrusion element are configured to form an electric field therebetween to cause the first material and the second, adhesive material to be drawn from the at least one extrusion element toward the substrate, and form a first plurality of fibers from the first material and a second plurality of adhesive fibers from the second, adhesive material. A basis weight of the second plurality of adhesive fibers is about equal to or less than a basis weight of the first plurality of fibers.

In some embodiments of the electrospray system, the basis weight of the second plurality of adhesive fibers is in a range from about 0.1 g/m² to about 10 g/m². In some embodiments, the basis weight of the first plurality of fibers is in a range from about 1 g/m² to about 1000 g/m².

In some embodiments of the electrospray system, an average diameter of the second plurality of adhesive fibers is about equal to or less than an average diameter of the first plurality of fibers. In some embodiments of the electrospray system, an average diameter of the second plurality of adhesive fibers is greater than an average diameter of the first plurality of fibers.

In some embodiments of the electrospray system, each of the second plurality of adhesive fibers independently comprises a diameter in a range from about 10 nm to about 10 μm. In some embodiments of the electrospray system, each of the first plurality of fibers independently comprises a diameter in a range from about 10 nm to about 100 μm.

In some embodiments of the electrospray system, the basis weight of the second plurality of adhesive fibers is less than the basis weight of the first plurality of fibers, and the average diameter of the second plurality of adhesive fibers is less than the average diameter of the first plurality of fibers.

In some embodiments of the electrospray system, the at least one extrusion element is configured to sequentially deliver the first material and the second, adhesive material. The sequential delivery of the first material and the second, adhesive material is distinguishable from simultaneous delivery thereof, and is meant to include instances in which the first material is delivered followed by delivery of the second, adhesive material or vice versa. In some embodiments, the first material and the second, adhesive material are sequentially delivered via the same extrusion element. In some embodiments, the electrospray system comprises a plurality of extrusion elements, where each extrusion element is configured to sequentially deliver the first material and the second, adhesive material. In some embodiments, the first material and the second, adhesive material are sequentially delivered via at least two different extrusion elements. In some embodiments, the electrospray system comprises a first plurality of extrusion elements configured to deliver the first material, and a second plurality of extrusion elements configured to deliver the second material, wherein the first and second materials are sequentially delivered.

In some embodiments of the electrospray system, the at least one extrusion element is configured to deliver the first material for formation of the first plurality of fibers directly on the substrate. In some embodiments of the spun-bonded system, the at least one extrusion element is configured to deliver the first material for formation of the first plurality of fibers directly on the substrate. In some embodiments of the melt-blown system, the at least one extrusion element is configured to deliver the first material for formation of the first plurality of fibers directly on the substrate. In some embodiments, the first material may comprise other non-woven structure, mesh structure, woven structure or membrane structure. In some embodiments of the electrospray system, the at least one extrusion element is configured to deliver the second, adhesive material for formation of the second plurality of adhesive fibers directly on the first plurality of fibers, such that the first plurality of fibers is positioned between the substrate and the second plurality of adhesive fibers. In some embodiments of the electrospray system, the at least one extrusion element is configured to deliver a third material on the second plurality of adhesive fibers, such that the second plurality of adhesive fibers is positioned between the first plurality of fibers and the third material. In some embodiments, the third material may comprise other non-woven structure, mesh structure, woven structure or membrane structure.

In some embodiments of the electrospray system, the at least one extrusion element is configured to deliver the third material directly on the substrate, such that the second plurality of adhesive fibers is positioned between the third material and the first plurality of fibers. In some embodiments, the third material has a non-woven structure such as spun-bonded media and melt-blown media.

In some embodiments in which the electrospray system is configured to deliver the first material on the substrate, and the second, adhesive material on the upper surface of the first material, a fourth material may be separately provided and applied to the upper surface of the second, adhesive material. In some embodiments, the fourth material comprises a non-woven structure, a mesh structure, a woven structure, or a membrane.

In some embodiments, the fourth material is provided and applied directed on the substrate, and the electrospray system is configured to deliver the second, adhesive material on the upper surface of the fourth material, and the first material on the upper surface of the second, adhesive material. In some embodiments, the fourth material comprises a non-woven structure, a mesh structure, a woven structure, or a membrane.

In some embodiments of the electrospray system, the at least one extrusion element is configured to simultaneously deliver the first material and the second, adhesive material to form a plurality of dual component adhesive fibers. In some embodiments of the electrospray system, the at least one extrusion element comprises one or more exterior outlets substantially surrounding one or more inner outlets, wherein each of the one or more exterior outlets is configured to deliver the second, adhesive material, and each of the one or more inner outlets is configured to deliver at least the first material. In some embodiments of the electrospray system, one or more of the inner outlets are further configured to deliver an additional material.

In some embodiments of the electrospray system, the at least one extrusion element comprises a nozzle comprising: a first end in fluid communication with a source of the first material and a source of the second, adhesive material, and a second end from which the first material and the second, adhesive material are each drawn toward the substrate. In some embodiments, the electrospray system comprises a plurality of the nozzles. In some embodiments, one or more of the nozzles are configured to deliver the first material, and one or more of the nozzles are configured to deliver the second, adhesive material. In some embodiments, at least one of the nozzles is configured to simultaneously deliver the first material and the second, adhesive material to form a plurality of dual component adhesive fibers. In some embodiments, at least one of the nozzles is configured to simultaneously deliver the first material, the second, adhesive material, and an additional material to form a plurality of multi-component fibers.

In some embodiments, the electrospray system comprises a solution dipping component comprising a plurality of the extrusion elements, wherein the solution dipping system is in contact with (i) a source of a second, adhesive material; or (ii) a mixed source comprising the first material and the second, adhesive material, wherein the second, adhesive material or the combination of the first material/second, adhesive material are drawn from the plurality of extrusion elements of the solution dipping component toward the substrate. In some embodiments, the solution dipping component has a rough exterior surface. In some embodiments, the solution dipping system has a smooth exterior surface. In some embodiments, the solution dipping component comprises a rotatable roller or ball. In some embodiments, the solution dipping component comprises a thread or chain connecting a plurality elements each independently having a smooth and/or rough exterior surface.

In some embodiments associated with the methods and/or electrospray systems disclosed herein, the substrate is conductive. In some embodiments associated with the methods and/or systems disclosed herein, the substrate is non-conductive.

### BRIEF DESCRIPTION OF THE DRAWINGS

Exemplary and non-limiting embodiments of the inventions may be more readily understood by referring to the accompanying drawings, in which:

FIGS. 1A-1D show cross-sectional, side views of a system configured for two-step formation of a self-adhesive fibrous medium, according to one embodiment.

FIGS. 2A-2C show simplified schematics of a top-down electrospinning process (FIG. 2A), a bottom-up electrospinning process (FIG. 2B), and a vertical electrospinning process (FIG. 2C), according to various embodiments.

FIGS. 3A-3C show cross-sectional, side views of a system for forming a self-adhesive fibrous medium, where the system comprises a single extrusion element (FIG. 3A), a plurality of extrusion elements (FIG. 3B), and at least two sets/groups of extrusion elements configured to extrude different materials or different combinations of materials (FIG. 3C), according to various embodiments.

FIGS. 4A-4B show cross-sectional, side views of a needleless (or needle-free) extrusion element comprising a solution dipping component having a rough surface (FIG. 4A) or a smooth surface (FIG. 4B).

FIGS. 4C-4D further show cross-sectional, side views of a needleless extrusion elements comprising a thread connecting a plurality of features each having a rough exterior surface (FIG. 4C) or a smooth exterior surface (FIG. 4D). FIGS.

4E-4H provide side views of dual component fibers produced from the needleless extrusion element of any one of FIGS. 4A-4D, where said fibers have an aggregate (FIG. 4E), a dispersed (FIG. 4F), a fully coated (FIG. 4G), and partially coated (FIG. 4H) structure, according to various embodiments.

FIGS. 4I-4L provide side views of multicomponent fibers produced from the needleless extrusion element of any one of FIGS. 4A-4D, where said fibers have an aggregate (FIG. 4I), a dispersed (FIG. 4J), a fully coated (FIG. 4K), and partially coated (FIG. 4L) structure, according to various embodiments.

FIGS. 5A-511 show various views of a system configured for one-step formation of a self-adhesive fibrous medium comprising dual or multicomponent adhesive fibers, according to one embodiment. For instance, FIGS. 5A-5B show a cross-sectional and a top-down view, respectively, of an embodiment in which the system comprises at least one extrusion element configured to form dual component (“sheath-core”) adhesive fibers, as described herein. FIGS. 5C-5D show a cross-sectional and a top-down view, respectively, of an embodiment in which the system comprises at least one extrusion element configured to form “island-in-sea” type dual component adhesive fibers, as described herein. FIG. 5E-5F show a cross-sectional and top-down view, respectively, of an embodiment in which the system comprises at least one extrusion element configured to form multicomponent (“coaxial”) adhesive fibers, as described herein. FIGS. 5G-5H show a cross-sectional and a top-down view, respectively, of an embodiment in which the system comprises at least one extrusion element configured to form “island-in-sea” type multicomponent (“coaxial”) adhesive fibers, as described herein.

FIGS. 6A-6D show cross-sectional views of a dual component (“sheath-core”) adhesive fiber (FIG. 6A), an “island-in-sea” type dual component adhesive fiber (FIG. 6B), a multicomponent “coaxial” adhesive fiber (FIG. 6C), and an “island-in-sea” type multicomponent “coaxial” adhesive fiber (FIG. 6D), according to various embodiments.

FIGS. 7A-7B show cross-sectional views of a dual-layer, self-adhesive fibrous medium in which one of the layers comprises dual or multicomponent adhesive fibers, as described herein, according to various embodiments.

FIGS. 8A-8B show cross-sectional, side views of a system configured for two-step formation of a self-adhesive fibrous medium comprising dual or multicomponent adhesive fibers, as described herein, according to one embodiment.

FIGS. 9A-9B show cross-sectional views of a tri-layer, self-adhesive fibrous medium, in which one of the layer comprises dual or multicomponent adhesive fibers, as described herein, according to various embodiments.

FIGS. 10A-10F provide top-down views of scaffolds comprising different types of extrusion elements, according to various embodiments.

FIGS. 10G-10H provide top-down views of a scaffold comprising a plurality of the same type of extrusion elements, according to various embodiments.

FIG. 11 is a flowchart of a method for forming a self-adhesive, dual or multilayer fibrous medium, according to one embodiment.

FIG. 12 is a flowchart of a method for forming a self-adhesive, single layer fibrous medium, according to one embodiment.

FIGS. 13A-13D show SEM images of an exemplary adhesive fibrous web in contact with one or more fibrous layers, where the adhesive fibrous web comprises a plurality of adhesive fibers having an average diameter of about 1 to about 2 μm.

FIGS. 14A-14B show SEM images of an exemplary adhesive fibrous web in contact with one or more fibrous layers, where the adhesive fibrous web comprises a plurality of adhesive fibers having an average diameter of about 300 nm.

FIGS. 15A-15B show images of adhesive systems produced via conventional roller and gun gluing systems, respectively.

### DETAILED DESCRIPTION

Described herein are devices, systems, and methods for the formation of unique self-adhesive fibrous media. In particular, the devices, systems, and methods described herein provide a new means of gluing low basis weight (e.g., less than 3 g/m²) fibrous media. In some embodiments, such gluing means may be achieved via formation of an adhesive fibrous web having, e.g., an average fiber diameter ranging from about 10 nm to about 10 μm, which allows for fine fiber-like gluing spots. This nanometer or sub-micron sized adhesive fibrous web has a high surface area, high barrier or filtration properties, good adhesive performance, and other such advantages over conventional fiber gluing systems.

### 1. SYSTEMS

a. System for Two-Step Formation of Self-Adhesive Fibrous Media

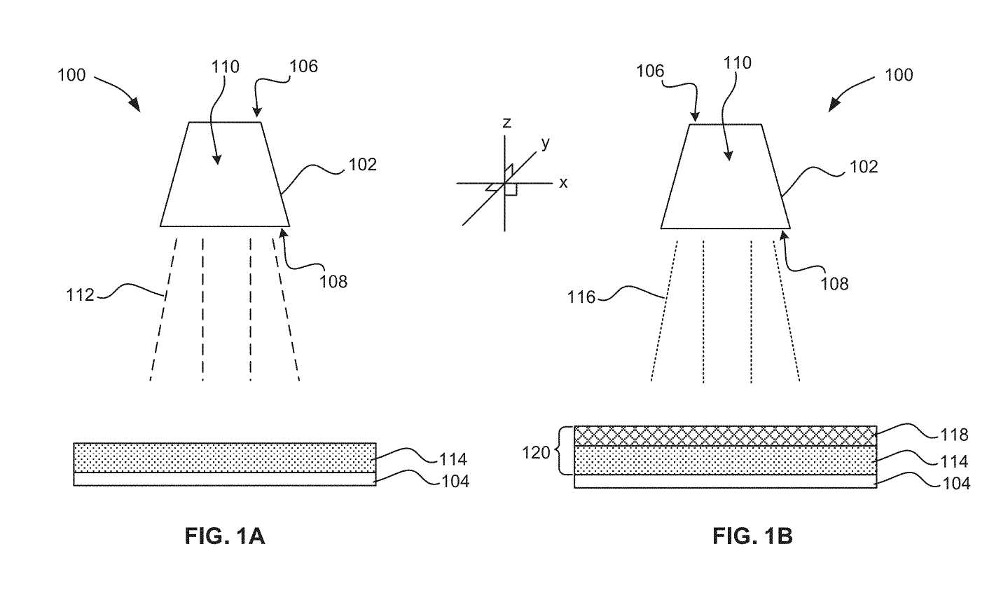

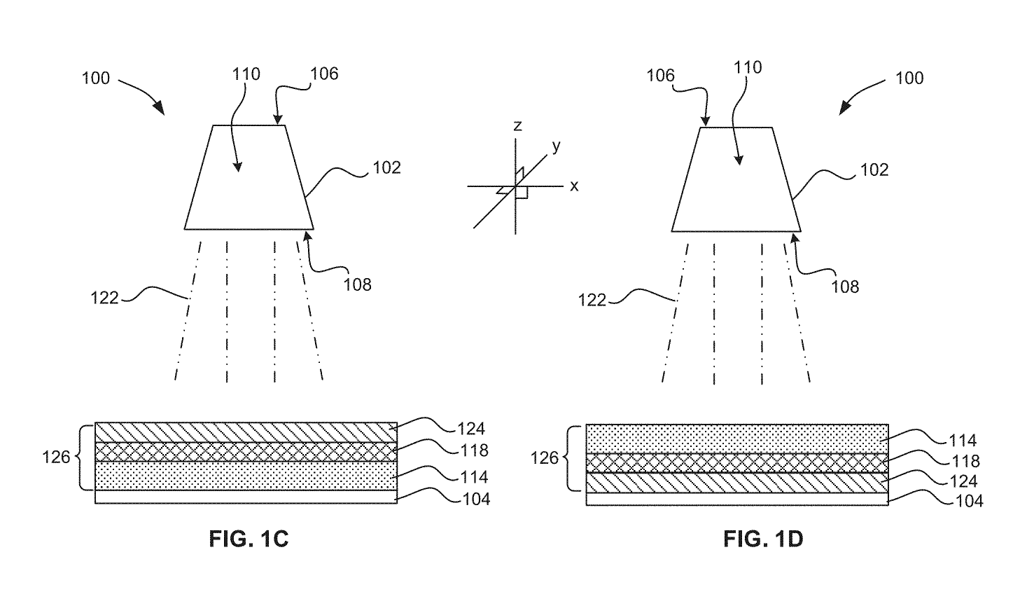

Referring now to FIGS. 1A-1D, cross-sectional, side views of a system 100 for forming a self-adhesive fibrous medium is shown in accordance with one embodiment. The system 100 or components/features thereof may be implemented in combination with, or as an alternative to, other devices/features/components described herein, such as those described with reference to other embodiments and FIGS. The system 100 may additionally be utilized in any of the methods for making and/or using such devices/components/features described herein. The system 100 may also be used in various applications and/or in permutations, which may or may not be noted in the illustrative embodiments described herein. For instance, the electrospray system 100 may include more or less features/components than those shown in FIGS. 1A-1D, in some embodiments. Moreover, the system 100 is not limited to the size, shape, number of components, etc. specifically shown in FIGS. 1A-1D.

In some embodiments, the system 100 may be configured to form the self-adhesive fibrous medium via a two-step process, described in detail below.

As shown in FIGS. 1A-1D, the system 100 comprises at least one extrusion element 102. As used herein, an extrusion element refers to a component configured to extrude a material to be formed into a fiber. In some embodiments, the material to be formed into a fiber exits, or is drawn from, the extrusion element 102 toward a substrate 104. In some embodiments, the substrate 104 may be conductive. In some embodiments, the substrate 104 may be non-conductive.

In some embodiments, the extrusion element 102 may comprise a first surface 106 in fluid communication with a first source (not shown in FIGS. 1A-1D) of material (e.g., a polymer solution or polymer melt) to be formed into fiber, and a second, opposing surface 108 from which the material is extruded. In some embodiments, the extrusion element 102 may also comprise at least one chamber or outlet 110 extending from the first and second surfaces, 106, 108, respectively, through which the material to be formed into a fiber may pass.

As particularly shown in FIG. 1A, the extrusion element 102 is configured to deliver a first material, which is extruded in the form of a first plurality of fibers 112. The first plurality of fibers 112 travel, or are drawn, toward the substrate 104 to form a first layer 114 (e.g., a fibrous web) thereupon.

In some embodiments, the first layer 114 may be formed via a spunbonding process, a melt-blown process, an air-laid process, a wet-laid process, a spun-lacing (hydro-entangling) process, a needle-punching process, an electrospinning (or electrospraying) process, or combinations thereof. In some embodiments, the first layer 114 may be formed via a spunbonding process, a melt-blown process, an electrospinning (or electrospraying), or combinations thereof. In some embodiments, the first layer 114 may be formed via an air-laid process, a wet-laid process, a spun-lacing (hydro-entangling) process, a needle-punching process, process, or combinations thereof. In some embodiments, the first layer 114 may be formed via a spunbonding process. In some embodiments, the first layer 114 may be formed via a melt-blown process. In some embodiments, the first layer 114 may be formed via an electrospinning (or electrospraying) process. In some embodiments, the first layer 114 may be formed via an air-laid process. In some embodiments, the first layer 114 may be formed via a wet-laid process. In some embodiments, the first layer 114 may be formed via a spun-lacing (hydro-entangling) process. In some embodiments, the first layer 114 may be formed via a needle-punching process.

In some embodiments, the first layer 114 may be formed via an electrospinning or electrospraying process. In embodiments in which electrospinning is utilized, an electric force can be applied to draw charged threads of the first material (e.g., a polymer solution or polymer melt) from the extrusion element 102 to form the first plurality of fibers 112.

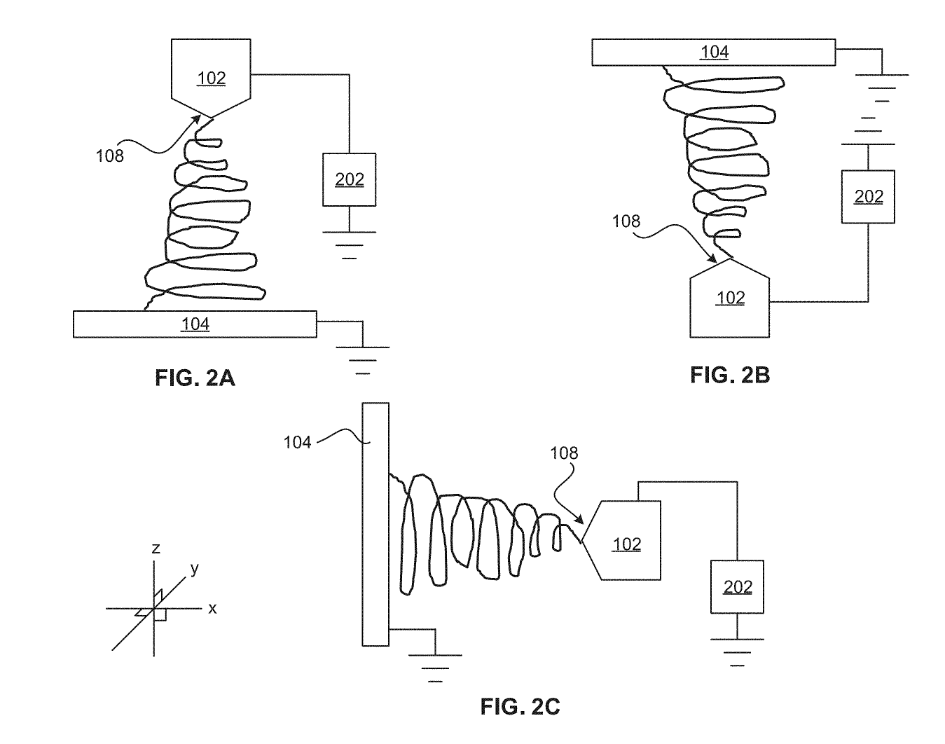

Cross-sectional, side views of simplified schematics of such an electrospinning or electrospraying process are provided in FIGS. 2A-2C, according to various embodiments. As shown in FIGS. 2A-2C, a power source 202 may be operatively coupled to the extrusion element 102 and configured to supply a high voltage thereto. When a sufficiently high voltage is applied to a liquid droplet formed near the second surface 108 of the extrusion element 102, the body of the liquid becomes charged, and electrostatic repulsion counteracts the surface tension such that the droplet is stretched, and, at a critical point, a stream of liquid erupts from the second surface 108. In instances where the molecular cohesion of the liquid is sufficiently high, stream breakup does not occur (if stream breakup does occur, droplets are electrosprayed) and a charged liquid jet is formed. As the jet dries in flight, the mode of current flow changes from ohmic to convective as the charge migrates to the surface of the fiber. The jet is then elongated by a whipping process caused by electrostatic repulsion initiated at small bends in the fiber, until it is finally deposited on the ground collector (the substrate 104). The elongation and thinning of the fiber resulting from this bending instability leads to the formation of uniform fibers with nanometer-scale diameters, in some embodiments.

As also shown in FIGS. 2A-2C, such electrospinning (or electrospraying) process may be a top-down process in which the extrusion element 102 is vertically positioned above the substrate 104 (FIG. 2A), and the fibers are generated downward; a bottom-up process in which the substrate 104 is vertically positioned above extrusion element 102 (FIG. 2B), and the fibers are generated in an upward direction; or a vertical process in which the substrate 104 is horizontally positioned relative to the extrusion element 102 (FIG. 2C), and the fibers are generated in horizontal/side-ways direction.

With continued reference to FIGS. 1A-1D, the first plurality of fibers 112 in the first layer 114 may have a basis weight in a range from about 0.1 g/m² to about 1,000 g/m², about 0.1 g/m² to about 500 g/m², about 0.5 g/m² to about 100 g/m², about 0.5 g/m² to about 50 g/m², or about 1 g/m² to about 10 g/m², in some embodiments. In some embodiments, the first plurality of fibers 112 in the first layer 114 may have a basis weight in a range between and including any two of the following: about 1 g/m², about 1.2 g/m², about 1.4 g/m², about 1.6 g/m², about 1.8 g/m², about 2 g/m², about 2.2 g/m², about 2.4 g/m², about 2.6 g/m², about 2.8 g/m², about 3 g/m², about 3.2 g/m², about 3.4 g/m², about 3.6 g/m², about 3.8 g/m², about 4 g/m², about 4.2 g/m², about 4.4 g/m², about 4.6 g/m², about 4.8 g/m², about 5 g/m², about 5.2 g/m², about 5.4 g/m², about 5.6 g/m², about 5.8 g/m², about 6 g/m², about 6.2 g/m², about 6.4 g/m², about 6.6 g/m², about 6.8 g/m², about 7 g/m², about 7.2 g/m², about 7.4 g/m², about 7.6 g/m², about 7.8 g/m², about 8 g/m², about 8.2 g/m², about 8.4 g/m², about 8.6 g/m², about 8.8 g/m², about 9 g/m², about 9.2 g/m², about 9.4 g/m², about 9.6 g/m², about 9.8 g/m², and about 10 g/m².

In some embodiments, the first plurality of fibers 112 in the first layer 114 may have an average diameter in a range from about 10 nm to about 100 μm, about 10 nm to about 1 μm, about 10 nm to about 500 nm, or about 30 nm to about 400 nm. In some embodiments, the first plurality of fibers 112 in the first layer 114 may have an average diameter in a range between and including any two of the following: about 30 nm, about 32 nm, about 34 nm, about 36 nm, about 38 nm, about 40 nm, about 42 nm, about 44 nm, about 46 nm, about 48 nm, about 50 nm, about 52 nm, about 54 nm, about 56 nm, about 58 nm, about 60 nm, about 62 nm, about 64 nm, about 66 nm, about 68 nm, about 70 nm, about 72 nm, about 74 nm, about 76 nm, about 78 nm, about 80 nm, about 82 nm, about 84 nm, about 86 nm, about 88 nm, about 90 nm, about 92 nm, about 94 nm, about 96 nm, about 98 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, and about 400 nm.

In some embodiments, exemplary materials for use in formation of the first plurality of fibers 112 of the first layer 114 may include, but are not limited to, polypropylene, polyethylene, poly(ethylene oxide), polyethylene terephthalate, nylon, polyvinyl alcohol, polyvinylpyrrolidone, polyvinylidene fluoride, polystyrene, polypropylene, polyethylene, poly(ethylene oxide), polyethylene terephthalate, polyacrylonitrile, polyimide, polyvinyl chloride, polycarbonate, polyurethane, polysulfone, polyactic acid, polytetrafluoroethylene, polybenzoxazoles, poly-aramid, poly(phenylene sulfide), poly-phenylene terephthalamide, polytetrafluoroethylene, and combinations thereof.

As particularly shown in FIG. 1B, the extrusion element 102 is configured to deliver a second, adhesive material, which is extruded in the form of a second plurality of adhesive fibers 116. The second plurality of adhesive fibers 116 travels, or is drawn, toward the substrate 104 to form a second layer 118 above the first layer 114. In some embodiments, the second plurality of adhesive fibers 116 may be formed directly on the first layer 114.

In some embodiments, the second layer 118 may be formed via an electrospinning (or electrospinning process) process as described above (see, e.g., FIGS. 2A-2C).

In some embodiments, the second plurality of adhesive fibers 116 in the second layer 118 may have a basis weight that is less than the basis weight of the first plurality of fibers 112 in the first layer 114. In some embodiments, the second plurality of adhesive fibers 116 in the second layer 118 may have a basis weight that is about equal to the basis weight of the first plurality of fibers 112 in the first layer 114. In some embodiments, the second plurality of adhesive fibers 116 in the second layer 118 may have a basis weight that is greater than the basis weight of the first plurality of fibers 112 in the first layer 114.

In some embodiments, the second plurality of adhesive fibers 116 in the second 118 may have a basis weight in a range from about 0.1 g/m² to about 10 g/m², about 0.2 g/m² to about 8 g/m², or about 0.3 g/m² to about 5 g/m². In some embodiments, the second plurality of adhesive fibers 116 in the second layer 118 may have a basis weight in a range between and including any two of the following: about 0.3 g/m², about 0.4 g/m², about 0.5 g/m², about 0.6 g/m², about 0.7 g/m², about 0.8 g/m², about 0.9 g/m², about 1 g/m², about 1.2 g/m², about 1.4 g/m², about 1.6 g/m², about 1.8 g/m², about 2 g/m², about 2.2 g/m², about 2.4 g/m², about 2.6 g/m², about 2.8 g/m², about 3 g/m², about 3.2 g/m², about 3.4 g/m², about 3.6 g/m², about 3.8 g/m², about 4 g/m², about 4.2 g/m², about 4.4 g/m², about 4.6 g/m², about 4.8 g/m², and about 5 g/m².

In some embodiments, the second plurality of adhesive fibers 116 in the second layer 118 may have an average diameter that is less than the average diameter of the first plurality of fibers 112 in the first layer 114. In some embodiments, the second plurality of adhesive fibers 116 in the second layer 118 may have an average diameter that is about equal to the average diameter of the first plurality of fibers 112 in the first layer 114. In some embodiments, the second plurality of adhesive fibers 116 in the second layer 118 may have an average diameter that is greater than the average diameter of the first plurality of fibers 112 in the first layer 114.

In some embodiments, the second plurality of adhesive fibers 116 in the second layer 118 may have an average diameter that is greater than, and a basis weight that is less than, the average diameter and the basis weight, respectively, of the first plurality of fibers 112 in the first layer 114. In some embodiments, the second plurality of adhesive fibers 116 in the second layer 118 may have an average diameter that is greater than, and a basis weight that is about equal to, the average diameter and the basis weight, respectively, of the first plurality of fibers 112 in the first layer 114. In some embodiments, the second plurality of adhesive fibers 116 in the second layer 118 may both have an average diameter and a basis weight that are greater than the average diameter and the basis weight, respectively, of the first plurality of fibers 112 in the first layer 114.

In some embodiments, the second plurality of adhesive fibers 116 in the second layer 118 may have an average diameter that about equal to, and a basis weight that is less than, the average diameter and the basis weight, respectively, of the first plurality of fibers 112 in the first layer 114. In some embodiments, the second plurality of adhesive fibers 116 in the second layer 118 may both have an average diameter and a basis weight that are about equal to the average diameter and the basis weight, respectively, of the first plurality of fibers 112 in the first layer 114. In some embodiments, the second plurality of adhesive fibers 116 in the second layer 118 may have an average diameter that is about equal to, and a basis weight that is greater than, the average diameter and the basis weight, respectively, of the first plurality of fibers 112 in the first layer 114.

In some embodiments, the second plurality of adhesive fibers 116 in the second layer 118 may both have an average diameter and a basis weight that is less than the average diameter and the basis weight, respectively, of the first plurality of fibers 112 in the first layer 114. In some embodiments, the second plurality of adhesive fibers 116 in the second layer 118 may have an average diameter that is less than, and a basis weight that is about equal to, the average diameter and the basis weight, respectively, of the first plurality of fibers 112 in the first layer 114. In some embodiments, the second plurality of adhesive fibers 116 in the second layer 118 may have an average diameter that is less than, and a basis weight that is greater than, the average diameter and the basis weight, respectively, of the first plurality of fibers 112 in the first layer 114.

In some embodiments, the second plurality of adhesive fibers 116 in the second layer 118 may have an average diameter in a range from about 10 nm to about 10 μm, about 10 nm to about 5 μm, about 10 nm to about 500 nm, or about 30 nm to 400 nm. In some embodiments, the second plurality of adhesive fibers 116 in the second layer 118 may have an average diameter in a range between and including any two of the following: about 30 nm, about 32 nm, about 34 nm, about 36 nm, about 38 nm, about 40 nm, about 42 nm, about 44 nm, about 46 nm, about 48 nm, about 50 nm, about 52 nm, about 54 nm, about 56 nm, about 58 nm, about 60 nm, about 62 nm, about 64 nm, about 66 nm, about 68 nm, about 70 nm, about 72 nm, about 74 nm, about 76 nm, about 78 nm, about 80 nm, about 82 nm, about 84 nm, about 86 nm, about 88 nm, about 90 nm, about 92 nm, about 94 nm, about 96 nm, about 98 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, and about 400 nm.

In some embodiments, exemplary materials for use in formation of the second plurality of adhesive fibers 116 of the second layer 118 may include, but are not limited to, a pressure sensitive adhesive polymer, a light sensitive adhesive polymer, a hot-melt adhesive polymer, and combinations thereof. In some embodiments, polymer materials or compositions for use in formation of the second plurality of adhesive fibers 116 may include, but are not limited to ethylene-vinyl acetate (EVA), polyolefins (PO), polyamides (PA), polyester, polyurethane (PU), an acrylic, bio-based acrylate, butyl rubber, nitriles, silicone rubber, styrene butadiene rubber, natural rubber latex, and combinations thereof.

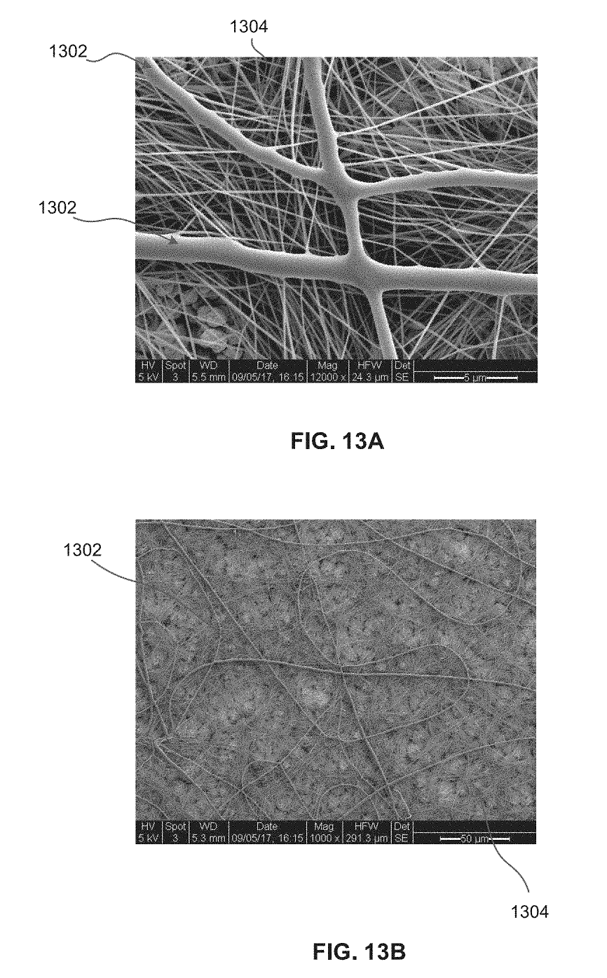

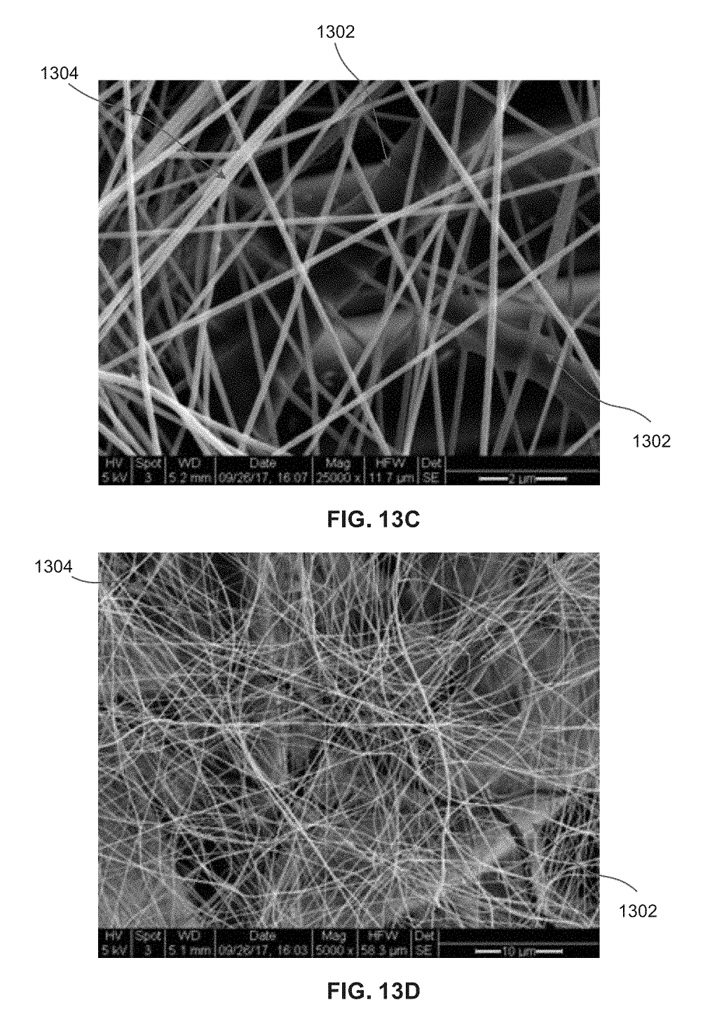

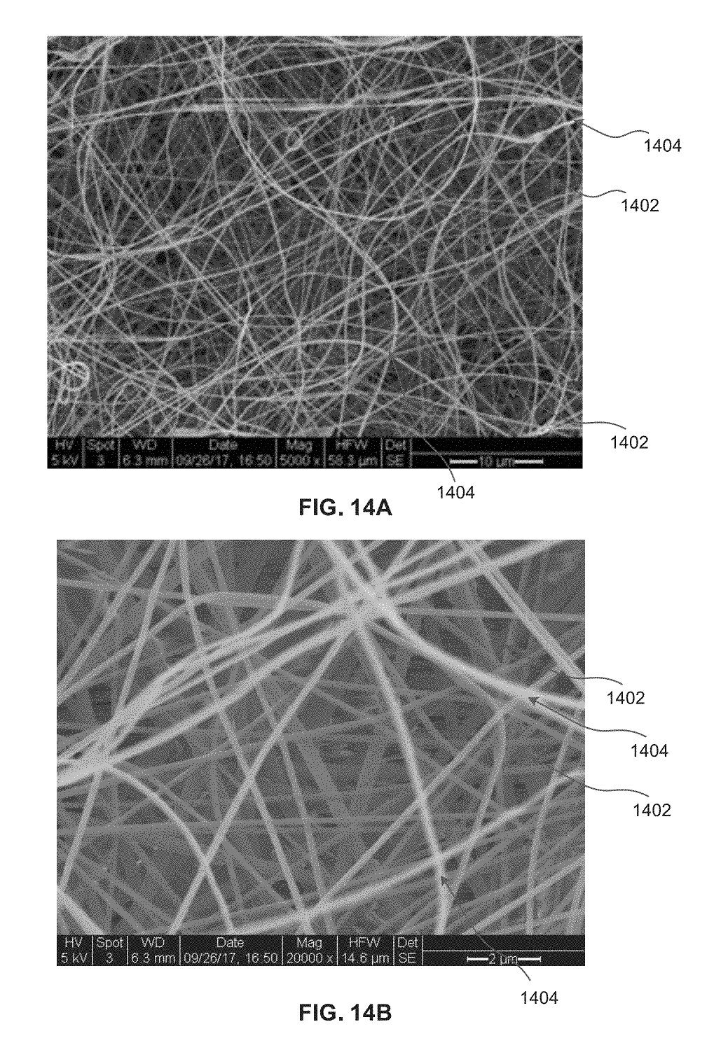

In some embodiments, at least a portion of the second plurality of adhesive fibers 116 in the second layer 118 may be oriented randomly relative to one another. See, e.g., the scanning electron microscope (SEM) images of FIGS. 13A-13D and FIGS. 14A-14B, which show such adhesive fibers randomly oriented with respect to one another.

In some embodiments, at least a portion of the second plurality of adhesive fibers 116 may not be oriented in a parallel arrangement. A parallel arrangement of fibers corresponds to instances in which the fibers are each oriented in substantially the same direction, and particularly where each fiber is oriented at an angle less than about 5 degrees, less than about 3 degrees, or less than about 1 degrees relative to that direction. If the substrate movement direction is defined as the main direction of the adhesive fiber web, each fiber can independently be defined in an angle category from 0 to about 179 degrees relative to the main direction. For example, a fiber lying parallel to the main direction will have a 0 degree angle relative to said direction, and a fiber lying perpendicular to the main direction will have about a 90 degree angle relative to said direction. In some embodiments, at least a majority or substantially all (e.g., at least about 80%, at least about 90%, at least about 95%) of the second plurality of adhesive fibers may not be in the same angle category (about 1 degree relative to the main direction). In some embodiments, at least a majority or substantially all (e.g., at least about 80%, at least about 90%, at least about 95%) of the second plurality of adhesive fibers may not be in the same about three degree angle category (e.g., about 3 degree relative to the main direction). In some embodiments, at least a majority or substantially all (e.g., at least about 80%, at least about 90%, at least about 95%) of the second plurality of adhesive fibers may not be in the same about five degree angle category e.g., (about 5 degree relative to the main direction).

In some embodiments, the resulting dual-layer, self-adhesive fibrous medium 120 (e.g., comprising the first and second layers 114, 118) may be removed from the substrate 104, where said substrate may then be used in additional fiber forming processes.

As particularly shown in FIG. 1C, the extrusion element 102 may be configured to optionally extrude a third material 122 toward the substrate 104 to form a third layer 124 above, or on, the second layer 118. In some embodiments, the third layer 124 may be formed directly on the second layer 118. The adhesive, second layer 118 may provide fine fiber-like “gluing spots/areas” and ensure good adhesion between the first and third layers 114, 124.

In some embodiments, the order of the layers 114, 118, 124 shown in FIG. 1C may be reversed. For instance, as shown in FIG. 1D, the extrusion element 102 may be configured to optionally form the third layer 124 on the substrate 104, followed by formation of the second layer 118 above, or on, the third layer 124, and formation of the first layer 114 above, or on, the second layer 118.

In some embodiments, the third layer 124 may comprise a non-woven structure.

In some embodiments, the third layer 124 may comprise one or more similar properties (e.g., basis weight, average fiber diameter, etc.) as the first and/or second layers 114, 118. In some embodiments, the third layer 124 may comprise one or more different properties (e.g., basis weight, average fiber diameter, etc.) as the first and/or second layers 114, 118.

In some embodiments, the third layer 124 may comprise one or more similar polymer materials as the first and/or second layers 114, 118. In some embodiments, the third layer 124 may comprise one or more different polymer materials as the first and/or second layers 114, 118.

While not shown in FIGS. 1A-1D, a fourth material may be provided. The fourth material may be used to form a fourth layer in combination with any of the layers described herein, or as an alternative to the first and/or third layer 114, 124. For instance, in some embodiments, a fourth material may be provided and applied directly to the substrate 104 to form a fourth layer thereon. The fourth material may be provided via a separate apparatus, via a separate polymer formation technique, and/or as a commercial available product The extrusion element 102 may then be configured to form the second layer 118 above, or on, the fourth layer, followed by formation of the first layer 114 above, or on, the second layer 118.

In some embodiments, the extrusion element 102 may be configured to form the first layer 114 directly on the substrate 104, followed by formation of the second layer 118 above, or on, the first layer. The fourth material may then be provided and applied as a fourth layer above, or on, the second layer 118.

In some embodiments, the fourth layer described herein may comprise a non-woven structure, a woven structures, a mesh structure, a membrane structure, or any combination thereof.

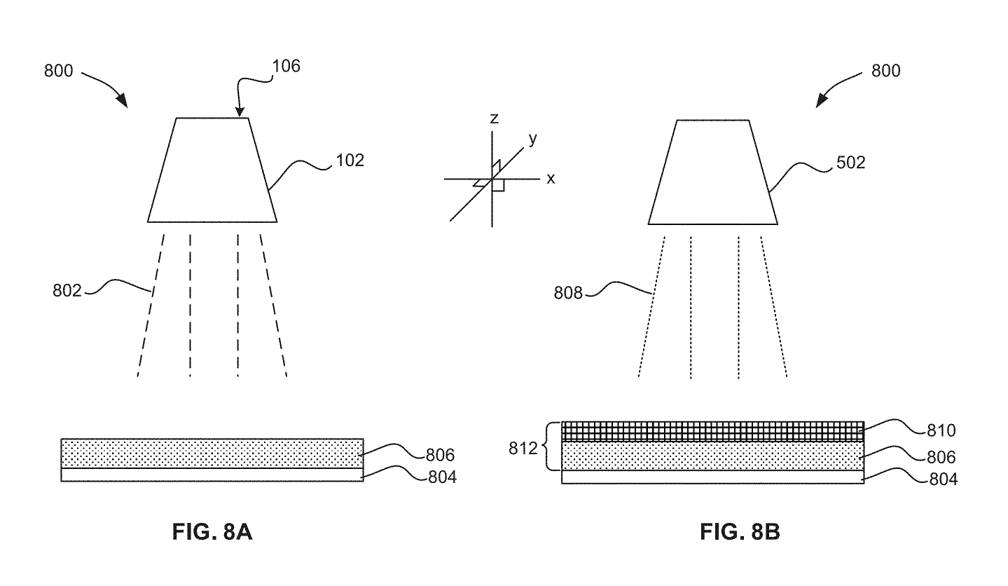

In some embodiments, the resulting tri-layer, fibrous medium (see, e.g., 124 or 126 of FIGS. 8A-8B) may be removed from the substrate 104, where said substrate may then be used in additional fiber forming processes.

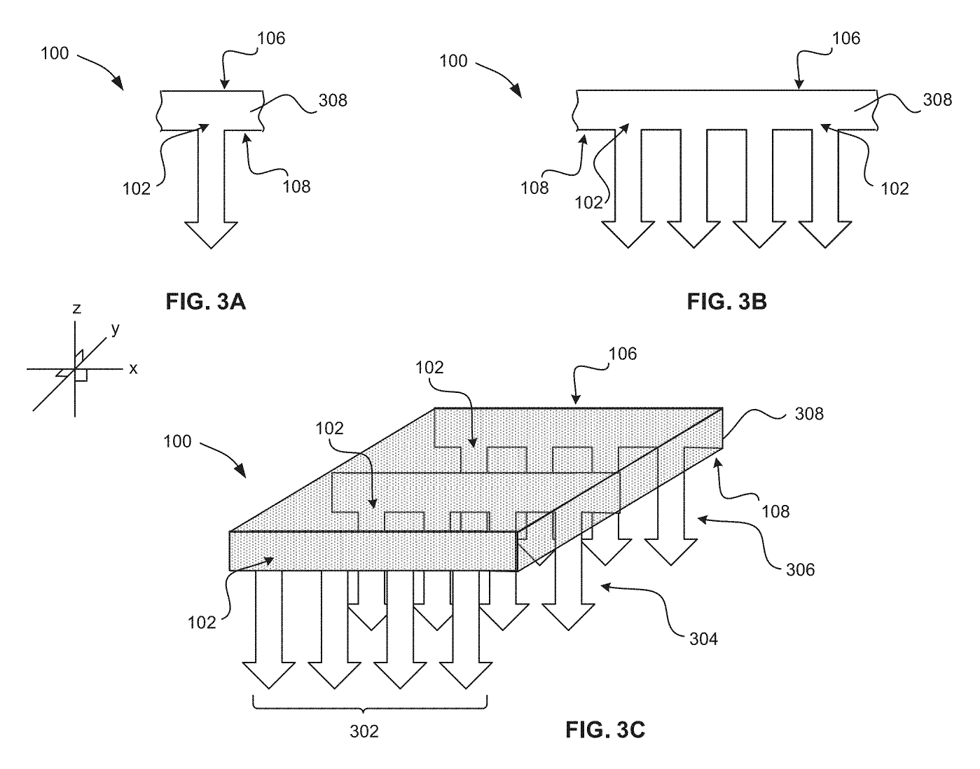

Still with reference to FIGS. 1A-1D, the system 100 may comprise a single extrusion element 102. This single extrusion element 102 may be configured to sequentially extrude one or more different materials (e.g., the first material, the second material, and/or optionally the third material as described herein) to form a multi-layer fibrous medium. In such embodiments, the single extrusion element 102 may be in fluid communication with each respective source (e.g., polymer solution or polymer melt) of the different materials. FIG. 3A provides a cross-sectional, side view of a simplified schematic of the system 100 comprising a single extrusion element 102, according to one embodiment.

In some embodiments, the system 100 may comprise a plurality of extrusion elements 102, as shown, e.g., in the cross-sectional, side view provided in FIG. 3B. In some embodiments, each of the plurality of extrusion elements 102 may independently be configured to sequentially extrude one or more different materials (e.g., the first material, the second material, and/or optionally the third material as described herein) to form a multi-layer fibrous medium. In such embodiments, each of the plurality of extrusion elements 102 may independently be in fluid communication with each respective source (e.g., polymer solution or polymer melt) of the different materials.

In some embodiments, each of the plurality of extrusion elements 102 may be independently configured to extrude one material (e.g., the first, second, or third material as described herein), sequentially extrude at least two materials (e.g., the first and second materials, the first and third materials, the second and third materials), sequentially extrude at least three materials (e.g., the first, second, and third materials), etc. For instance, in some embodiments, at least one of the extrusion elements 102 may only be in fluid communication with the source of the first material, and thus only configured to extrude the first material; whereas, at least another of the extrusion elements 102 may only be in fluid communication with the source of the second material, and thus only configured to extrude the second material. In some embodiments, at least one of the extrusion elements 102 may be in fluid communication with the sources of the first and second materials, and thus able to sequentially extrude the first and second materials; whereas, at least another of the extrusion elements 102 may only be in fluid communication with the source of the third material, and thus only configured to extrude the third material. It is note, that each extrusion element 102 may be individually tailored to extrude the desired material or sequential combination of materials described herein.

In some embodiments, the system 100 may comprise at least two sets/groups of extrusion elements 102, where each set/group is configured to extrude different materials or different combinations of materials relative to one another, and where each set/group may independently comprises at least two extrusion elements 102. For instance, in one such embodiment, a first set of extrusion elements 102 may be configured to extrude the first material as described herein, and a second set of extrusion elements 102 may be configured to extrude the second material as described herein. In another such embodiment, a first set of extrusion elements 102 may be configured to sequentially extrude the first material and the second material as described herein, and a second set of extrusion elements 102 may be configured to extrude the third material as described herein.

FIG. 3C provides a cross-sectional, side view of the system 100 comprising at least three sets/groups 302, 304, 306 of extrusion elements 102. Each of the at least three sets 302, 304, 306 of extrusion elements 102 may be configured to extrude a different material or a different combination of materials relative to one another. For instance, a first set 302 of extrusion elements 102 may be configured to extrude the first material as described herein; a second set 304 of extrusion elements 102 may be configured to extrude the second material as described herein; and a third set 306 of extrusion elements 102 may be configured to extrude the third material as described herein. In some embodiments, the system 100 may further comprise one or more additional sets (e.g., a fourth, fifth, sixth, seventh, etc. set) of extrusion elements 102, where each of the one or more additional sets may independently be configured for extrusion of the first material, the second material, the third material, or an additional material (e.g., different from the first, second, and third materials).

In embodiments in which the system 100 comprises a single extrusion element 102 or a plurality of extrusion elements 102 (such as shown, e.g., in FIGS. 3A-3C), the system 100 may comprise a scaffold 308 that is coupled to, and supports, the extrusion element(s) 102. In some embodiments, the scaffold 308, and particularly the outer periphery thereof, may have a shape selected from a rectangle, a triangle, a parallelogram, an echelon, a hexagon, an octagon, a circle, a square, or an irregular shape.

In some embodiments, the scaffold 308 may comprise a total number of extrusion elements 102 ranging from about 1 extrusion element to about 5000 extrusion elements, about 5 to about 2500 extrusion elements, about 10 to about 1000 extrusion elements, or about 20 to about 500 extrusion elements. In some embodiments, the scaffold 308 may comprise a total number of extrusion elements 108 ranging between and including any two of the following values: about 1, about 2, about 4, about 6, about 8, about 10, about 12, about 14, about 16, about 18, about 20, about 40, about 60, about 80, about 100, about 120, about 140, about 160, about 180, about 200, about 220, about 240, about 260, about 280, about 300, about 320, about 340, about 360, about 380, about 400, about 420, about 440, about 460, about 480, about 500, about 520, about 540, about 560, about 580, about 600, about 620, about 640, about 660, about 680, about 700, about 720, about 740, about 760, about 780, about 800, about 820, about 840, about 860, about 880, about 900, about 920, about 940, about 960, about 980, about 1000, about 1050, about 1100, about 1150, about 1200, about 1250, about 1300, about 1350, about 1400, about 1450, about 1500, about 1550, about 1600, about 1650, about 1700, about 1750, about 1800, about 1850, about 1900, about 1950, about 2000, about 2050, about 2100, about 2150, about 2200, about 2250, about 2300, about 2350, about 2400, about 2450, about 2500, about 2550, about 2600, about 2650, about 2700, about 2750, about 2800, about 2850, about 2900, about 2950, about 3000, about 3050, about 3100, about 3150, about 3200, about 3250, about 3300, about 3350, about 3400, about 3450, about 3500, about 3550, about 3600, about 3650, about 3700, about 3750, about 3800, about 385, about 3900, about 3950, about 4000, about 4050, about 4100, about 4150, about 4200, about 4250, about 4300, about 4350, about 4400, about 4450, about 4500, about 4550, about 4600, about 4650, about 4700, about 4750, about 4800, about 4850, about 4900, about 4950, and about 5000.

In embodiments in which the system 100 comprises a single extrusion element 102 or a plurality of extrusion elements 102 (such as shown, e.g., in FIGS. 3A-3C), each extrusion element 102 may independently have a cross-sectional shape (as taken substantially parallel to the x-axis shown, e.g., in FIGS. 3A-3C) selected from a rectangle, a triangle, a parallelogram, an echelon, a hexagon, an octagon, a circle, a square, an irregular shape, or any suitable shape as would become apparent to one having skill in the art upon reading the present disclosure. In some embodiments, each extrusion element 102 may independently have a first cross-sectional shape at or near the first surface 106 and a second cross-sectional shape at or near the second surface 108. In some embodiments, the first cross-sectional shape and the second cross-sectional shape may each independently be selected from a rectangle, a triangle, a parallelogram, an echelon, a hexagon, an octagon, a circle, a square, an irregular shape, or any suitable shape as would become apparent to one having skill in the art upon reading the present disclosure. In some embodiments, this first cross-sectional shape may be different than the second cross-sectional shape. In some embodiments, this first cross-sectional shape may be the same as the second cross-sectional shape.

In embodiments in which the system comprises a plurality of extrusion elements 102 (such as shown, e.g., in FIGS. 3B-3C), at least two of the extrusion elements 102 may have the same cross-sectional shape as one another. In some embodiments, a majority of the extrusion elements 102 may have the same cross-sectional shape as one another. In some embodiments, each of the extrusion elements 102 may have the same cross-sectional shape as one another.

In embodiments in which the system comprises a plurality of extrusion elements 102 (such as shown, e.g., in FIGS. 3B-3C), at least two of the extrusion elements 102 may have different cross-sectional shapes as one another. In some embodiments, a majority of the extrusion elements 102 may have different cross-sectional shapes as one another. In some embodiments, each of the extrusion elements 102 may have a different cross-sectional shape.

In embodiments in which the system comprises a plurality of extrusion elements 102 (such as shown, e.g., in FIGS. 3B-3C), the extrusion elements 102 may be arranged according to a predetermined pattern. For instance, in some embodiments, at least a portion, a majority, substantially all, or all of the extrusion elements 102 may be arranged according to a substantially triangular pattern, a substantially parallelogram pattern, a substantially echelon pattern, a substantially hexagonal pattern, or a substantially square pattern. In some embodiments, at least a portion, a majority, substantially all, or all of the extrusion elements 102 may be arranged according to a combination of any of the aforementioned patterns. Such combinations may include, but are not limited to, a combination of octagonal and rectangular patterns, a combination of echelon and triangular patterns, and a combination of hexagonal and parallelogram patterns. In some embodiments, at least a portion, a majority, substantially all, or all of the extrusion elements 102 may be arranged according to a random or irregular pattern.

In embodiments in which the system comprises a plurality of extrusion elements 102 (such as shown, e.g., in FIGS. 3B-3C), an average distance between adjacent extrusion elements 102 may be in a range from about 0.1 cm to about 100 cm. In some embodiments, an average distance between adjacent extrusion elements 102 may be in a range between and including any two of the following: about 0.1 cm, about 0.5 cm, about 1 cm, about 2 cm, about 4 cm, about 6 cm, about 8 cm, about 10 cm, about 12 cm, about 14 cm, about 16 cm, about 18 cm, about 20 cm, about 22 cm, about 24 cm, about 26 cm, about 28 cm, about 30 cm, about 32 cm, about 34 cm, about 36 cm, about 38 cm, about 40 cm, about 42 cm, about 44 cm, about 46 cm, about 48 cm, about 50 cm, about 52 cm, about 54 cm, about 56 cm, about 58 cm, about 60 cm, about 62 cm, about 64 cm, about 66 cm, about 68 cm, about 70 cm, about 72 cm, about 74 cm, about 76 cm, about 78 cm, about 80 cm, about 82 cm, about 84 cm, about 86 cm, about 88 cm, about 90 cm, about 92 cm, about 94 cm, about 96 cm, about 98 cm, and about 100 cm.

In embodiments in which the system comprises a plurality of extrusion elements (such as shown, e.g., in FIGS. 3B-3C), the distance between extrusion elements 102 may be substantially uniform. In some embodiments, the distance between extrusion elements 102 may not be substantially uniform.

In embodiments in which the system 100 comprises a single extrusion element 102 or a plurality of extrusion elements 102 (such as shown, e.g., in FIGS. 3A-3C), each extrusion element 102 may independently have a maximum diameter that is at least about 100 μm, at least about 150 μm, at least about 200 μm, at least about 250 μm, at least about 300 μm, at least about 350 μm, at least about 400 μm, at least about 450 μm, at least about 500 μmat least about 550 μm, at least about 600 μm, at least about 650 μm, at least about 700 μm, at least about 750 μm, at least about 800 μm, at least about 850 μm, at least about 900 μm, at least about 950 μm, at least about 0.1 cm, at least about 0.5 cm, at least about 1 cm, at least about 1.5 cm, or at least about 2 cm.

In some embodiments, each extrusion element 102 may independently have a diameter in a range from about 100 μm to about 2 cm. In some embodiments, each extrusion element 102 may independently have a maximum diameter in a range between and including any two of the following: about 100 μm, about 120 μm, about 140 μm, about 160 μm, about 180 μm, about 200 μm, about 220 μm, about 240 μm, about 260 μm, about 280 μm, about 300 μm, about 320 μm, about 340 μm, about 360 μm, about 380 μm, about 400 μm, about 420 μm, about 440 μm, about 460 μm, about 480 μm, about 500 μm, about 520 μm, about 540 μm, about 560 μm, about 580 μm, about 600 μm, about 620 μm, about 640 μm, about 660 μm, about 680 μm, about 700 μm, about 720 μm, about 740 μm, about 760 μm, about 780 μm, about 800 μm, about 820 μm, about 840 μm, about 860 μm, about 880 μm, about 900 μm, about 0.1 cm, about 0.2 cm, about 0.4 cm, about 0.8 cm, about 1 cm, about 1.2 cm, about 1.4 cm, about 1.6 cm, about 1.8 cm, and about 2 cm.

In some embodiments, each extrusion element 102 may independently have a maximum distance that is substantially uniform along the length thereof, where the length is measured substantially parallel to the z-axis of FIGS. 3A-3C. In some embodiments, each extrusion element 102 may independently have a maximum distance that is not substantially uniform along the length thereof. For instance, in some embodiments, each extrusion element 102 may independently have a maximum distance that increases from the first surface 106 to the second surface 108 of the extrusion element 102. In some embodiments, each extrusion element 102 may independently have a maximum distance that decreases from the first surface 106 to the second surface 108 of the extrusion element 102.

In some embodiments, each extrusion element 102 may independently be oriented substantially perpendicular to the plane extending along the first surface 106 and/or the second surface 108 of the extrusion element 102. In some embodiments, however, each extrusion element 102 may be independently oriented at a non-right angle relative to the plane extending along the first surface 106 and/or the second surface 108 of the extrusion element 102, thereby allowing fibers to be extruded therefrom at an acute angle. The ability to independently customize the relative angle of the each extrusion element 102 may facilitate the tuning of the orientation/alignment of the formed fibers. Thus, in some embodiments, each extrusion element 102 may independently be oriented from about 10° to about 90° relative to the plane extending along the first surface 106 and/or the second surface 108 of the extrusion element 102.

In some embodiments, each extrusion element 102 may independently be a nozzle (e.g., a needle nozzle) or a “needleless” (“needle-free”) extrusion element.

For an extrusion element 102 that is a nozzle, the first surface 106 of the nozzle or nozzle-like extrusion element 102 may be in fluid communication with the material to be formed into fiber; the second surface (e.g., 108) may be in the form of a tip (e.g., a needle, etc.) from which the material is extruded; and the outlet/chamber may extend from the first surface 106 to the second surface 108 and allows passage of the material therethrough.

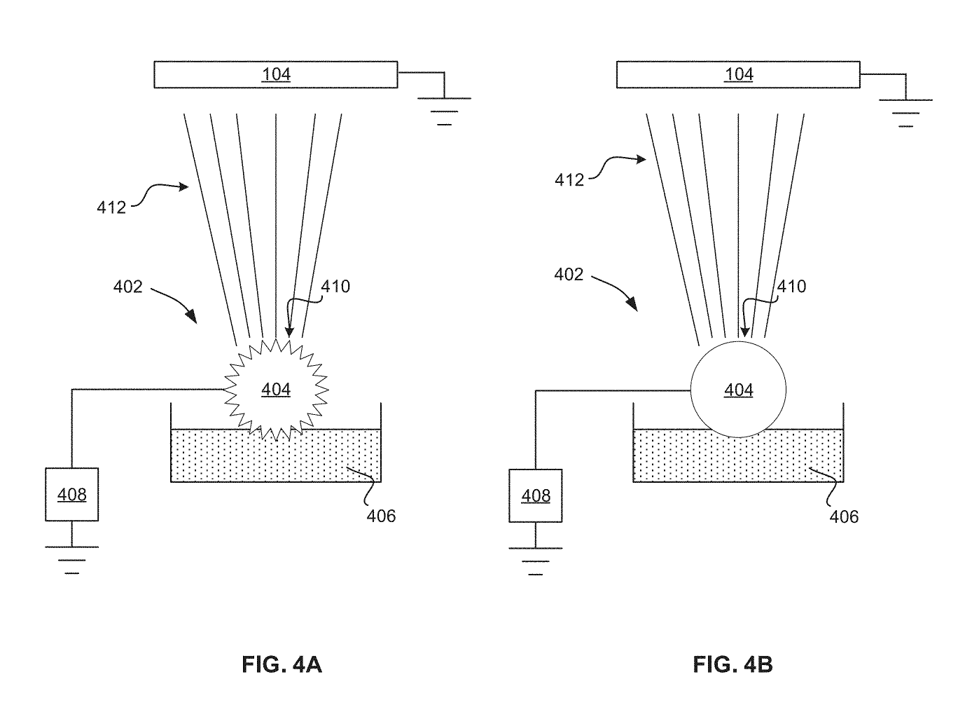

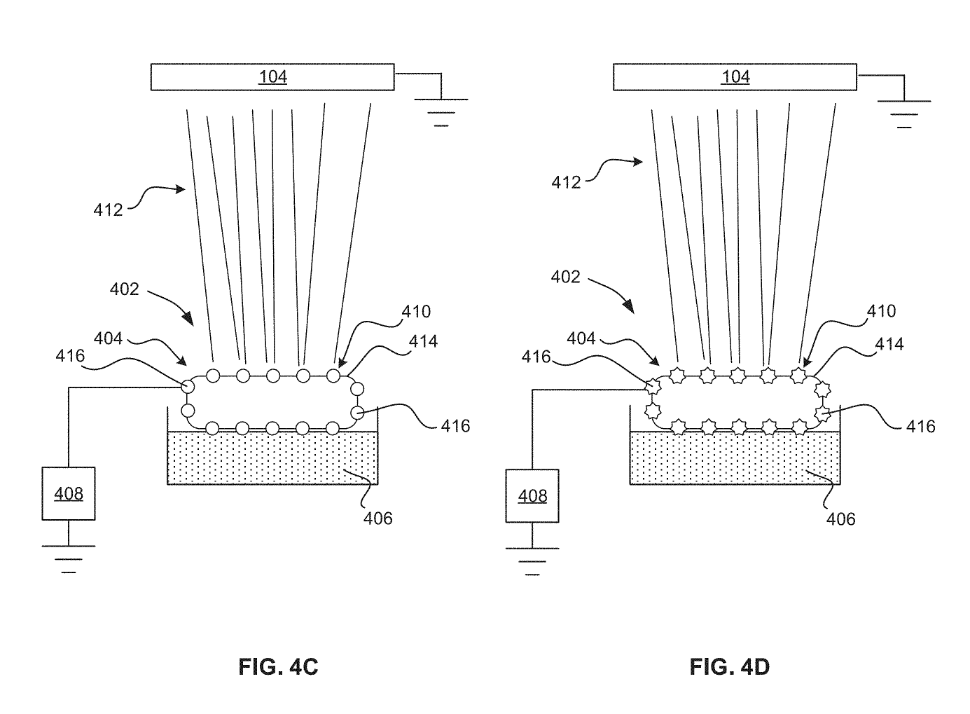

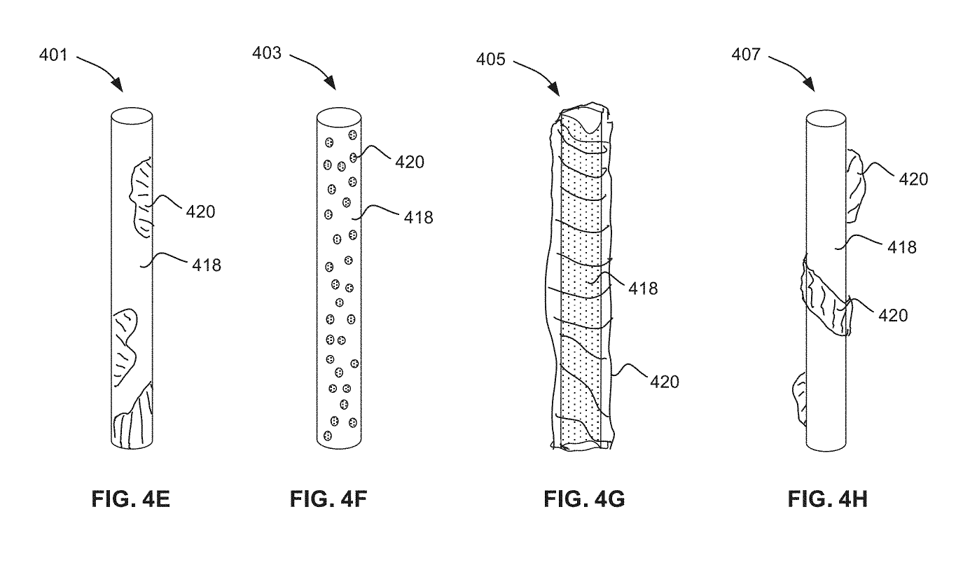

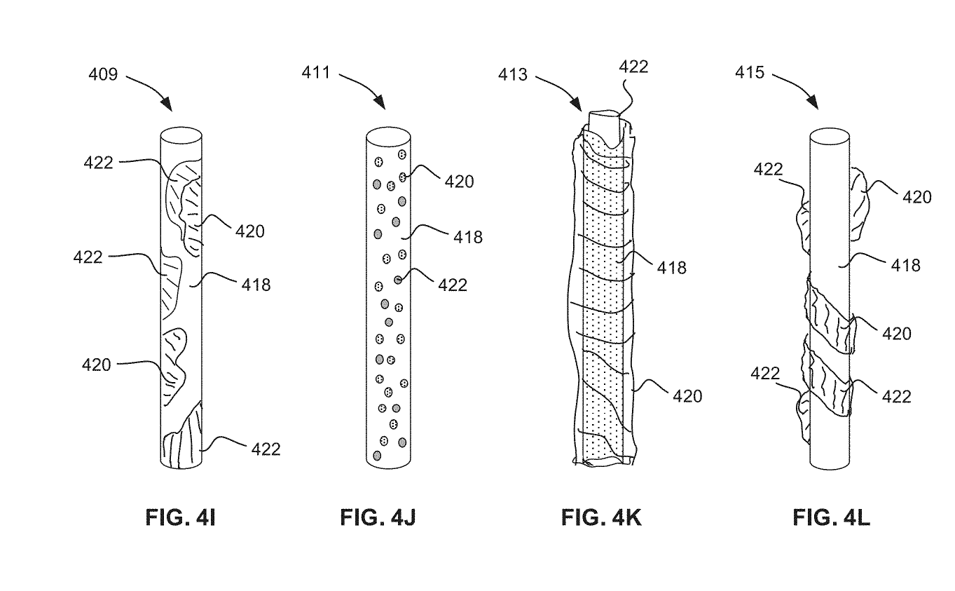

For an extrusion element 102 that is a “needleless” (or “needle-free”) extrusion element, said extrusion element 102 may not comprise the first and second surfaces 106, 108, and the outlet as discussed above. Reference is made, for example, to FIGS. 4A-4B, which provide various embodiments of a “needleless” or “needle-free” extrusion element 402.

As shown in FIGS. 4A-4B, the needle-free extrusion element 402 may comprise a solution dipping component 404 in contact with a solution 406 (i.e., the source of the material to be formed into fiber). The needle-free extrusion element 402 may be operatively coupled to a power source 408 configured to supply a high voltage thereto. In some embodiments, such as shown, e.g., in FIGS. 4A-4B, the power source 408 may be coupled to the solution dipping component 404. However, in some embodiments, the power source 408 may be coupled to the solution 406, and particularly the container in which said solution 406 is disposed.

The solution dipping component 404 may be configured to rotate, such that the dipping solution is loaded onto the surface 410 of the dipping component 404. The dipping solution may form conical spikes on the surface 410 of the dipping component 404 due to rotation thereof. Upon application of a sufficiently high voltage, the conical spikes may concentrate the electrical charges and further stretch (e.g., form Taylor cones) when the electrostatic repulsion counteracts the surface tension. Once a critical point is reached, streams of liquid (e.g., solution jets) may erupt from the surface 410 of the of the dipping component 404 to form fibers 412, which are collected on the ground collector (e.g., the substrate 106) positioned vertically above the needle-free extrusion element 402.

In some embodiments, the surface 410 of the dipping component 404 may be rough or smooth. FIG. 4A illustrates one embodiment in which the surface 410 of the dipping component 404 is rough, and particularly comprises a plurality of fabricated spikes. Conversely, FIG. 4B illustrates one embodiment in which the surface 410 of the dipping component 404 is substantially smooth.

FIGS. 4C-4D provide additional embodiments of a needle-free extrusion element 402, in which the solution dipping component 404 comprises a thread (or chain) 414 connecting a plurality of dipping elements 416. The thread 414 may be configured to rotate so as to allow the dipping elements 416 to be coated with the solution 406. These dipping elements 416 may have a substantially rough exterior surface 410, as shown in the embodiment of FIG. 4C, or a substantially smooth exterior surface 410, as shown in the embodiment of FIG. 4D.

In some embodiments of FIGS. 4A-4D, the solution 406 may comprise a polymer solution or polymer melt. In some embodiments, the solution 406 may comprise the second material for formation of the second plurality of adhesive fibers 116. In some embodiments, the solution 406 may comprise the first material for formation of the first plurality of fibers 112, and the second material for formation of the second plurality of adhesive fibers 116. In some embodiments, this mixture of the first and second materials may be homogenous. In some embodiments, this mixture of the first and second materials may be non-homogenous.

In some embodiments in which the solution 406 comprises a mixture of the first and second materials, phase separation thereof may occur during the electrospinning/electrospraying thereof, thus dual component may be produced (see, e.g., FIGS. 4E-41I).

As shown in the embodiment of FIG. 4E, a dual component, aggregate type fiber 401 may comprise at least a first polymer material 418 and at least a second polymer material 420 dispersed within one or more portions of the first polymer material 418.

FIG. 4F provides an embodiment of a dual component, dispersed type fiber 403 comprising at least a first polymer material 418 and at least a second polymer material 420 dispersed within/throughout the first polymer material 418. In some embodiments of the dual component, dispersed type fiber 403, the second polymer material 420 may be uniformly dispersed within/throughout the first polymer material 418.

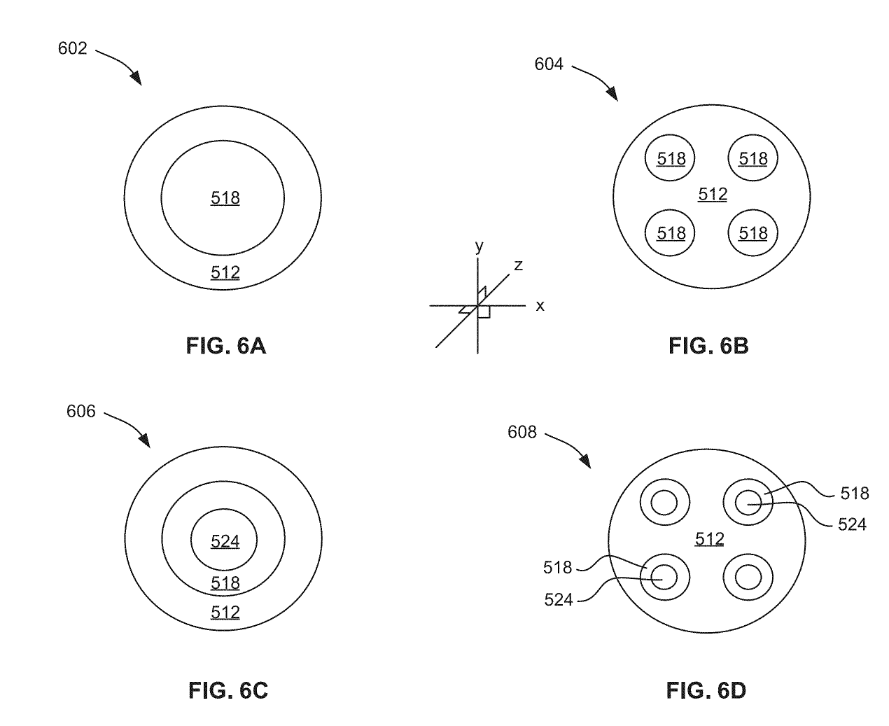

FIG. 4G provides an embodiment of a dual component, fully coated fiber 405 comprising at least a first polymer material 418 and at least a second polymer material 420 substantially coating (e.g., surrounding/encircling) the first polymer material 418. It is of note that the dual component, fully coated fiber 405 differs from a dual component, sheath-core type fiber (discussed, e.g., with respect to FIG. 6A) in that the dual component, fully coated fiber 405 does not have a substantially uniform cross-section. For instance, one or more cross-sections of the dual component, fully coated fiber 405 may differ with respect to the shape and amount of the second polymer material 420. In some embodiments, the cross-sectional shape of the combination of the first and second polymer materials 418, 420 may vary at each cross-section of the fiber 405.

FIG. 4H provides an embodiment of a dual component, partially coated fiber 407 comprising at least a first polymer material 418 and at least a second polymer material 420 coating (e.g., surrounding/encircling) one or more portions the first polymer material 418. In contrast to the dual component, fully coated fiber 405 of FIG. 4E, the second polymer material 420 of the dual component, partially coated fiber 407 may not coat (e.g. surround/encircle) all portions of the inner first polymer material 418. However, similar to the dual component, fully coated fiber 405 of FIG. 4F, the dual component, partially coated fiber 407 does not have a uniform cross-section. For instance, one or more cross-sections of the dual component, partially coated fiber 407 may differ with respect to the shape and amount of the second polymer material 420 surrounding/encircling the inner first polymer material 418. Moreover, there may be one or more regions of the dual component, partially coated fiber 407 that include solely the first polymer material 418 with no coating of the second polymer material 420 thereon.

In some embodiments, the first polymer material 418 of the fibers 401, 403, 405, 407 described in FIGS. 4E-4H may comprise the first material used for formation of the first plurality of fibers 112, as described herein, whereas the second polymer material 420 may comprise the second adhesive material used for formation of the second plurality of adhesive fibers 114, as described herein. In some embodiments, the first polymer material 418 of the fibers 401, 403, 405, 407 described in FIGS. 4E-4H may comprise the second adhesive material used for formation of the second plurality of adhesive fibers 114, as described herein, whereas the second polymer material 420 may comprise the first material used for formation of the first plurality of fibers 112, as described herein.

In some embodiments of FIGS. 4A-4D, the solution 406 may comprise a mixture of the first and second materials, as described herein, as well as one or more additional material (e.g., such as the third material, as described herein). Similar to above, the mixture of the first, second and additional materials in the solution 406 may be homogenous or non-homogenous.

In some embodiments in which the solution 406 comprises the first material, the second material, and one or more additional materials, phase separation said materials may occur during the electrospinning/electrospraying thereof, thus multi component fibers may be produced (see, e.g., FIGS. 4I-4L).

As shown in the embodiment of FIG. 4I, a multicomponent, aggregate type fiber 409 may comprise at least a first polymer material 418, wherein one or more portions of the first polymer 418 each independently comprise at least a second polymer material 420 or at least one additional polymer material 422 or a combination of the second and addition polymer materials 420, 422 dispersed therein.

FIG. 4J provides an embodiment of a multicomponent, dispersed type fiber 411 comprising at least a first polymer material 418, and at least a second polymer material 420 and at least one additional polymer material 422 dispersed within/throughout the first polymer material 418. In some embodiments of the multicomponent, dispersed type fiber 411, the second polymer 420 and the additional polymer material 422 may be uniformly dispersed within/throughout the first polymer material 418.

FIG. 4K provides an embodiment of a multicomponent, fully coated fiber 413 comprising at least an intermediate, first polymer material 418 substantially coating (e.g., surrounding/encircling) at least one, innermost additional polymer material 422, and at least an outer, second polymer material 420 substantially coating (e.g., surrounding/encircling) the intermediate first polymer material 418. It is of note that the multicomponent, fully coated fiber 413 differs from a multicomponent, sheath-core type fiber (discussed, e.g., with respect to FIG. 6C) in that the multicomponent, fully coated fiber 413 does not have a substantially uniform cross-section. For instance, one or more cross-sections of the multicomponent, fully coated fiber 413 may differ with respect to the shape and amount of the first polymer material 418 and/or the second polymer material 420. In some embodiments, the cross-sectional shape of the combination of the first, second, and additional polymer materials 418, 420, 422 may vary at each cross-section of the fiber 413.

FIG. 4L provides an embodiment of a multicomponent, partially coated fiber 415 comprising at least an intermediate, first polymer material 418 coating (e.g., surrounding/encircling) one or more portions of at least one, innermost additional polymer material 422, and at least an outer, second polymer material 420 coating (e.g., surrounding/encircling) one or more portions the intermediate, first polymer material 418. In contrast to the multicomponent, fully coated fiber 413 of FIG. 4K, the second polymer material 420 of the multicomponent, partially coated fiber 415 may not coat (e.g. surround/encircle) all portions of the intermediate first polymer material 418, and/or the first polymer material 418 may not coat all portions of the innermost, additional polymer material 422. However, similar to the multicomponent, fully coated fiber 413 of FIG. 4K, the multicomponent, partially coated fiber 415 does not have a uniform cross-section. For instance, one or more cross-sections of the multicomponent, partially coated fiber 415 may differ with respect to the shape and amount of the first polymer material 418 and/or the second polymer material 420 surrounding/encircling the innermost, additional polymer material 422. Moreover, there may be one or more regions of the multicomponent, partially coated fiber 415 that include solely the additional polymer material 422 with no coating of the first polymer material 418 and/or the second polymer material 420 thereon.

In some embodiments, the first polymer material 418 of the fibers 409, 411, 413, 415 described in FIGS. 4I-4L may comprise the first material used for formation of the first plurality of fibers 112, as described herein; the second polymer material 420 may comprise the second adhesive material used for formation of the second plurality of adhesive fibers 114, as described herein; and the additional polymer material(s) 422 may comprise a non-adhesive or adhesive material as described herein. In embodiments in which the second polymer 420 and the additional polymer material(s) 422 may each comprise an adhesive material, said adhesive materials may be different from one another. In embodiments in which the first polymer 418 and the additional polymer material(s) 422 may each comprise a non-adhesive material, said non-adhesive materials may be different from one another. In some embodiments, the first polymer material 418, the second polymer material 420, and the additional polymer material(s) 422 of the fibers 409, 411, 413, 415 described in FIGS. 4I-4L may each independently comprise an adhesive or non-adhesive material, provided that the one or more portions of the outermost layer of respective fiber is adhesive.

b. System for One-Step Formation of Self-Adhesive Fibrous Media Comprising Dual or Multicomponent Adhesive Fibers

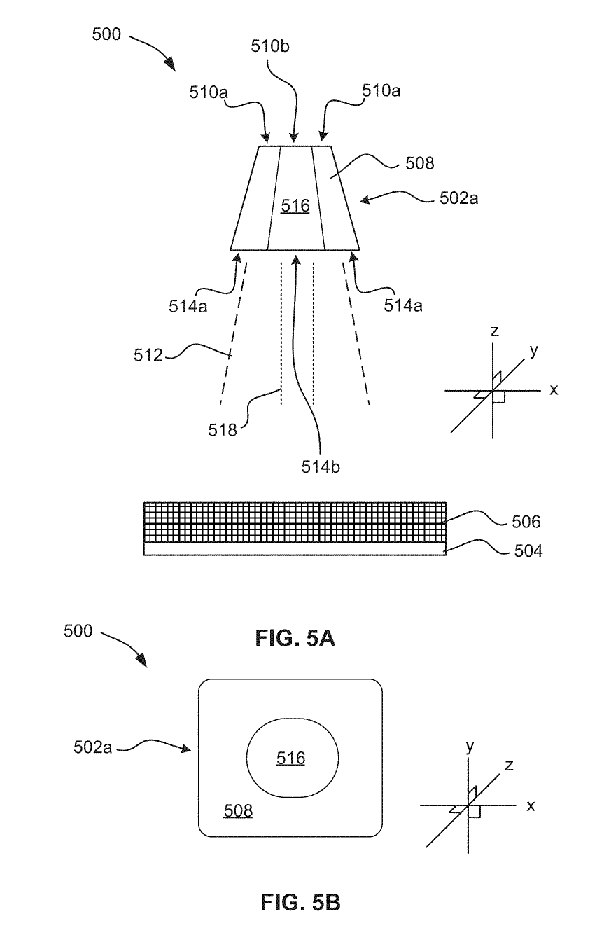

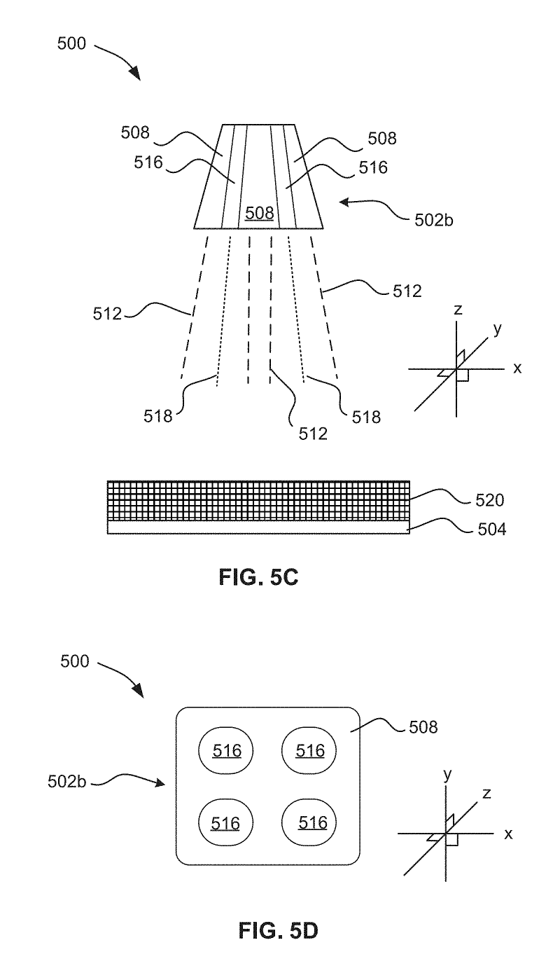

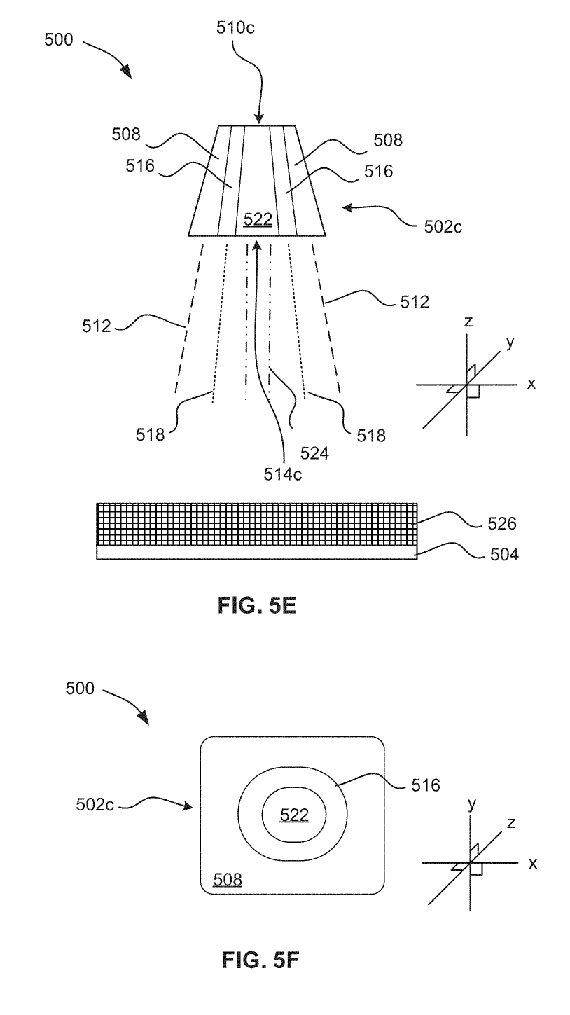

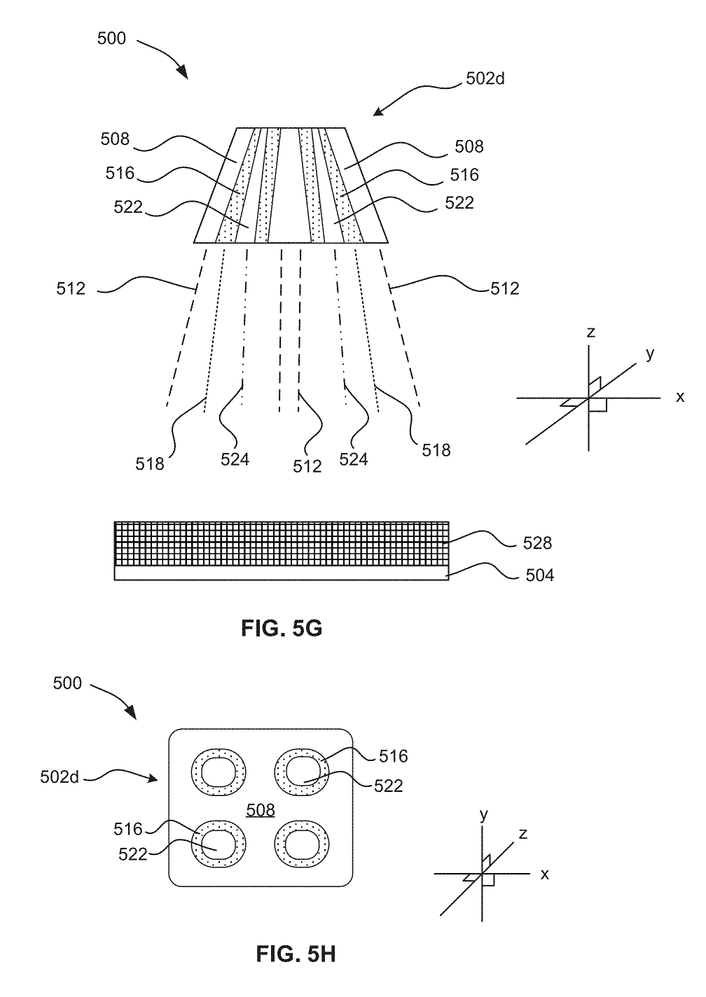

Referring now to FIGS. 5A-5H, cross-sectional, side views of a system 500 for forming a self-adhesive fibrous medium comprising dual or multicomponent adhesive fibers is shown, in accordance with one embodiment. The system 500 or components/features thereof may be implemented in combination with, or as an alternative to, other devices/features/components described herein, such as those described with reference to other embodiments and FIGS. The system 500 may additionally be utilized in any of the methods for making and/or using such devices/components/features described herein. The system 500 may also be used in various applications and/or in permutations, which may or may not be noted in the illustrative embodiments described herein. For instance, the electrospray system 500 may include more or less features/components than those shown in FIGS. 5A-5H, in some embodiments. Moreover, the system 500 is not limited to the size, shape, number of components, etc. specifically shown in FIGS. 5A-5H.

In some embodiments, the system 500 may be configured to form the self-adhesive fibrous medium via a one-step process, described in detail below.

As shown in FIGS. 5A-5H, the system 500 may comprise at least one extrusion element 502 configured to form dual or multicomponent adhesive fibers. In some embodiments, the materials to be formed into the dual or multicomponent adhesive fibers exit, or are drawn from, the extrusion element 502 toward a substrate 504 to form a single layer 506 thereon. In some embodiments, the substrate 504 may be conductive. In some embodiments, the substrate 504 may be non-conductive.

In some embodiments, the single layer 506 comprised of dual or multicomponent adhesive fibers may be at least partially or completely formed via an electrospinning (or electrospraying) process, as described herein. In some embodiments, such electrospinning (or electrospraying) process may be a top-down process (see, e.g., FIG. 2A); a bottom-up process (see, e.g., FIG. 2B); or a vertical process (see, e.g., FIG. 2C).

FIGS. 5A-5B provide a cross-sectional and a top-down view, respectively, of an embodiment in which the system 500 comprises at least one extrusion element 502a configured to form dual component (“sheath-core”) adhesive fibers. The at least one extrusion element 502a may comprise at least one of a first chamber or outlet 508 having a first surface 510a in fluid communication with a first source (not shown) of a first material 512 (e.g., polymer solution of melt), and a second surface 514a from with the first material 512 is extruded. The at least one extrusion element 502a may further comprise at least one of a second chamber or outlet 516 having a first surface 510b in fluid communication with a second source (not shown) of a second material 518 (e.g., polymer solution or melt), and a second surface 514b from which the second material 518 is extruded. In some embodiments, the first and second outlets 508, 516 may simultaneously extrude the first and second materials 512, 518 to form dual component adhesive fibers, which may travel, or be drawn, toward the substrate 504 to form a single layer 506 thereupon.

In some embodiments, the first outlet 508 may be positioned along one or more portions of the outer periphery of the extrusion element 502a, whereas the second outlet 516 may be positioned within an interior portion of the extrusion element 502a. In some embodiments, the first outlet 508 may be concentrically disposed about the inner, second outlet 516.

In some embodiments, the second outlet 516 may have a cross-sectional shape that is substantially rounded (e.g., circular, elliptical, etc.). In some embodiments, the first outlet 508 may have a cross sectional shape that is substantially rounded (e.g., circular, elliptical, etc.), square, rectangular, irregular, or other such suitable shape as would become apparent to a skilled artisan upon reading the present disclosure.

FIG. 6A provides a cross-sectional view of a dual component (“sheath-core”) adhesive fiber 602 (as taken perpendicular to the longitudinal axis thereof) produced by the at least one extrusion element 502a of FIGS. 5A-5B. As shown in FIG. 6A, the resulting dual component adhesive fiber 602 may comprise the first material 512 substantially surrounding/encircling the second material 518.

In some embodiments, the first material 512 of the dual component adhesive fiber 602 may be an adhesive material. In some embodiments, the first material 512 of the dual component adhesive fiber 602 may comprise a pressure sensitive adhesive polymer, a light sensitive adhesive polymer, a hot-melt adhesive polymer, or combinations thereof. In some embodiments, the first material 512 of the dual component adhesive fiber 602 may comprise an adhesive polymer material or composition thereof selected from ethylene-vinyl acetate (EVA), polyolefins (PO), polyamides (PA), polyester, polyurethane (PU), an acrylic, bio-based acrylate, butyl rubber, nitriles, silicone rubber, styrene butadiene rubber, natural rubber latex, and combinations thereof.

In some embodiments, the second material 518 of the dual component adhesive fiber 602 may comprise a non-adhesive or an adhesive material.

In some embodiments, the second material 518 of the dual component adhesive fiber 602 may comprise a non-adhesive polymer material selected from polypropylene, polyethylene, poly(ethylene oxide), polyethylene terephthalate, nylon, polyvinyl alcohol, polyvinylpyrrolidone, polyvinylidene fluoride, polystyrene, polypropylene, polyethylene, poly(ethylene oxide), polyethylene terephthalate, polyacrylonitrile, polyimide, polyvinyl chloride, polycarbonate, polyurethane, polysulfone, polyactic acid, polytetrafluoroethylene, polybenzoxazoles, poly-aramid, poly(phenylene sulfide), poly-phenylene terephthalamide, polytetrafluoroethylene, and combinations thereof.

In some embodiments, the second material 518 of the dual component adhesive fiber 602 may comprise an adhesive polymer material. In such embodiments, the second material 518 may comprise a different adhesive polymer or a different adhesive polymer composition than that of the first material 512. In some embodiments, the first material 512 and the second material 518 of the dual component adhesive fiber 602 may each independently comprise a pressure sensitive adhesive polymer, a light sensitive adhesive polymer, a hot-melt adhesive polymer, or combinations thereof, provided that the first and second materials 512, 518 comprise different adhesive polymers or different adhesive polymer compositions. In some embodiments, the first material 512 and the second material 518 of the dual component adhesive fiber 602 may each independently comprise an adhesive polymer material or composition thereof selected from ethylene-vinyl acetate (EVA), polyolefins (PO), polyamides (PA), polyester, polyurethane (PU), an acrylic, bio-based acrylate, butyl rubber, nitriles, silicone rubber, styrene butadiene rubber, natural rubber latex, and combinations thereof, provided that the first and second materials 512, 518 comprise different adhesive polymers or different adhesive polymer compositions.

FIGS. 5C-5D provide a cross-sectional and a top-down view, respectively, of another embodiment in which the system 500 comprises at least one extrusion element 502b configured to form dual component adhesive fibers in which one or more “islands” of the second material 518 are disposed within a “sea” of the first material 512. As shown in the top down view provided in FIG. 5D, the at least one extrusion element 502b may, in some embodiments, comprise four of the second outlets 516 in spaced relation with one another, and further disposed within an interior portion of the first outlet 508. In some embodiments, the first and second outlets 508, 516 may simultaneously extrude the first and second materials 512, 518, respectively, to form “islands-in-sea” type dual component adhesive fibers, which may travel, or be drawn, toward the substrate 504 to form a single layer 520 thereupon.

FIG. 6B provides a cross-sectional view of an “islands-in-sea” type dual component adhesive fiber 604 (as taken perpendicular to the longitudinal axis thereof) produced by the at least one extrusion element 502b of FIGS. 5C-5D. As shown in FIG. 6B, the resulting “islands-in-sea” type dual component adhesive fiber 604 may comprise an outer region substantially surrounding/encircling four separate inner regions (islands), where the outer region comprises the first material 512 and each of the inner regions (islands) comprises the second material 518.

It is of note that the at least one extrusion element 502b of FIGS. 5C-5D is not limited to the number or configuration of the second outlets 516. Rather, the at least one extrusion element 502b may include any number or configuration of the second outlets 516 so as to achieve a desired number and configuration of the second material 516 “islands” disposed within the “sea” of the first material 512.

Moreover, each of the second outlets 516 may extrude the same polymer or polymer composition as one another. However, in some embodiments, at least one of the second outlets 516 may extrude a different polymer or different polymer composition relative to at least another of the second outlets 516. Accordingly, in some embodiments, each of the second outlets may independently extrude a non-adhesive or adhesive polymer material as described herein.

FIGS. 5E-5F provide a cross-sectional and top-down view, respectively, of an embodiment in which the system 500 comprises at least one extrusion element 502c configured to form multicomponent (“coaxial”) adhesive fibers. The at least one extrusion element 502c may comprise at least the first outlet 508 and at least the second outlet 516 configured to extrude the first material 512 and the second material 518, respectively, as described above. The at least one extrusion element 502b may further comprise at least a third chamber or outlet 522 having a first surface 510c in fluid communication with a third source (not shown) of a third material 524 (e.g., polymer solution of melt), and a second surface 514c from which the third material 524 is extruded. In some embodiments, the first, second, and third outlets 508, 516, 522 may simultaneously extrude the first, second, and third materials 512, 518, 524, respectively to form multicomponent adhesive fibers, which may travel, or be drawn, toward the substrate 504 to form a single layer 526 thereupon.

In some embodiments, the third outlet 522 may be positioned within the innermost region of the extrusion element 502b, the second outlet 516 may surround one or more portions of the third outlet 522, and the first outlet 508 may surround one or more portions of the second outlet 516. In some embodiments, the second outlet 516 may be concentrically disposed about the innermost third outlet 522, and the first outlet 508 may be concentrically disposed about the middle, second outlet 516.

In some embodiments, the second outlet 516 and/or the third outlet 522 may each independently have a cross-sectional shape that is substantially rounded (e.g., circular, elliptical, etc.). Moreover, as noted previously, the first outlet 508 may have a cross sectional shape that is substantially rounded (e.g., circular, elliptical, etc.), square, rectangular, irregular, or other such suitable shape, in some embodiments.

FIG. 6C provides a cross-sectional view of a multicomponent adhesive fiber 606 (as taken perpendicular to the longitudinal axis thereof) produced by the at least one extrusion element 502c of FIGS. 5E-5F. As shown in FIG. 6C, the resulting multicomponent adhesive fiber 602 may comprise an outer region comprising the first material 512, a middle region comprising the second material 518, and a core/innermost region comprising the third material 524.

In some embodiments, the first material 512 of the multicomponent adhesive fiber 606 may be an adhesive material. In some embodiments, the first material 512 of the multicomponent adhesive fiber 606 may comprise a pressure sensitive adhesive polymer, a light sensitive adhesive polymer, a hot-melt adhesive polymer, or combinations thereof. In some embodiments, the first material 512 of the multicomponent adhesive fiber 606 may comprise an adhesive polymer material or composition thereof selected from ethylene-vinyl acetate (EVA), polyolefins (PO), polyamides (PA), polyester, polyurethane (PU), an acrylic, bio-based acrylate, butyl rubber, nitriles, silicone rubber, styrene butadiene rubber, natural rubber latex, and combinations thereof.

In some embodiments, the second material 518 and the third material 524 of the multicomponent adhesive fiber 606 may each independently comprise a non-adhesive or an adhesive material.

In some embodiments, the second material 518 and/or the third material 524 of the multicomponent adhesive fiber 606 may each independently comprise a non-adhesive polymer material selected from polypropylene, polyethylene, poly(ethylene oxide), polyethylene terephthalate, nylon, polyvinyl alcohol, polyvinylpyrrolidone, polyvinylidene fluoride, polystyrene, polypropylene, polyethylene, poly(ethylene oxide), polyethylene terephthalate, polyacrylonitrile, polyimide, polyvinyl chloride, polycarbonate, polyurethane, polysulfone, polyactic acid, polytetrafluoroethylene, polybenzoxazoles, poly-aramid, poly(phenylene sulfide), poly-phenylene terephthalamide, polytetrafluoroethylene, and combinations thereof. In some embodiments, the second material 518 and the third material 524 of the multicomponent adhesive fiber 606 each comprise a non-adhesive polymer material, provided that the second and third materials 518, 524 comprise different non-adhesive polymers or different non-adhesive polymer compositions.

In some embodiments, the second material 518 and/or the third material 524 of the multicomponent adhesive fiber 606 may each independently comprise an adhesive polymer material. In such embodiments, the first, second, and third materials 512, 518, 524 may comprise a different adhesive polymer or a different adhesive polymer composition than one another. In some embodiments, the first, second, and third materials 512, 518, 524 may each independently comprise a pressure sensitive adhesive polymer, a light sensitive adhesive polymer, a hot-melt adhesive polymer, or combinations thereof, provided that the first, second, and third materials 512, 518, 524 comprise a different adhesive polymer or different adhesive polymer composition relative to one another. In some embodiments, the first, second, and third materials 512, 518, 524 may each independently comprise an adhesive polymer material or composition thereof selected from ethylene-vinyl acetate (EVA), polyolefins (PO), polyamides (PA), polyester, polyurethane (PU), an acrylic, bio-based acrylate, butyl rubber, nitriles, silicone rubber, styrene butadiene rubber, natural rubber latex, and combinations thereof, provided that the first, second, and third materials 512, 518, 524 comprise a different adhesive polymer or different adhesive polymer composition as one another.

FIGS. 5G-5H provide a cross-sectional and top-down view of another embodiment in which the system 500 comprises at least one extrusion element 502d configured to form multicomponent (“coaxial”) adhesive fibers in which “islands” comprised of the second and third material 518, 524 are disposed within a “sea” of the first material 512. As shown in the top down view provided in FIG. 5H, the at least one extrusion element 502d may comprise four of the second outlets 516 in spaced relation with one another, and further disposed within an interior portion of the first outlet 508, where each of the second outlets 516 are concentrically disposed around an inner third outlet 522. In some embodiments, the first, second, and third outlets 508, 516, 522 may simultaneously extrude the first, second, and third materials 512, 518, 524, respectively, to form “islands-in-sea” type multicomponent adhesive fibers, which may travel, or be drawn, toward the substrate 504 to form a single layer 528 thereupon.

FIG. 6D provides a cross-sectional view of an “islands-in-sea” type, multicomponent adhesive fiber 608 (as taken perpendicular to the longitudinal axis thereof) produced by the at least one extrusion element 502d of FIGS. 5E-5F. As shown in FIG. 6D, the resulting “islands-in-sea” type multicomponent adhesive fiber 608 may comprise four separate islands of the second material 518 substantially surrounding/encircling the third material 524, where each of the four separate islands are themselves substantially surrounded/encircled by the first material 512.

It is of note that the at least one extrusion element 502d of FIGS. 5G-5H is not limited to the number or configuration of the second outlets 516 or third outlets 522. Rather, the extrusion element 502d may include any number or configuration of the second outlets 516 and/or third outlets 522 so as to achieve a desired number and configuration of the “islands” comprising the second material 518 and/or the third material 524, and which are disposed within the “sea” of the first material 512.

Moreover, in some embodiments, each of the second outlets 516 may extrude the same polymer or polymer composition as one another. However, in some embodiments, at least one of the second outlets 516 may extrude a different polymer or different polymer composition relative to at least another of the second outlets 516. In some embodiment, each of the third outlets 522 may extrude the same polymer or polymer composition as one another. In some embodiments, however, at least one of the third outlets 522 may extrude a different polymer or different polymer composition relative to at least another of the third outlets 522. In some embodiments, each of the second outlets 516 and the third outlets 522 may independently extrude a non-adhesive or adhesive polymer material as described herein.

With reference to FIGS. 5A-5H, the single layer (506, 520, 526, or 528) may have a basis weight in a range from about 0.1 g/m² to about 1,000 g/m², about 0.1 g/m² to about 500 g/m², about 0.5 g/m² to about 100 g/m², about 0.5 g/m² to about 50 g/m², or about 1 g/m² to about 10 g/m², in some embodiments. In some embodiments, the single layer (506, 520, 526, or 528) may have a basis weight in a range between and including any two of the following: about 1 g/m², about 1.2 g/m², about 1.4 g/m², about 1.6 g/m², about 1.8 g/m², about 2 g/m², about 2.2 g/m², about 2.4 g/m², about 2.6 g/m², about 2.8 g/m², about 3 g/m², about 3.2 g/m², about 3.4 g/m², about 3.6 g/m², about 3.8 g/m², about 4 g/m², about 4.2 g/m², about 4.4 g/m², about 4.6 g/m², about 4.8 g/m², about 5 g/m², about 5.2 g/m², about 5.4 g/m², about 5.6 g/m², about 5.8 g/m², about 6 g/m², about 6.2 g/m², about 6.4 g/m², about 6.6 g/m², about 6.8 g/m², about 7 g/m², about 7.2 g/m², about 7.4 g/m², about 7.6 g/m², about 7.8 g/m², about 8 g/m², about 8.2 g/m², about 8.4 g/m², about 8.6 g/m², about 8.8 g/m², about 9 g/m², about 9.2 g/m², about 9.4 g/m², about 9.6 g/m², about 9.8 g/m², and about 10 g/m².

In some embodiments, the single layer (506, 520, 526, or 528) may have an average fiber diameter in a range from about 10 nm to about 100 μm, about 10 nm to about 1 μm, about 10 nm to about 500 nm, or about 30 nm to about 400 nm. In some embodiments, the single layer (506, 520, 526, or 528) may have an average fiber diameter in a range between and including any two of the following: about 30 nm, about 32 nm, about 34 nm, about 36 nm, about 38 nm, about 40 nm, about 42 nm, about 44 nm, about 46 nm, about 48 nm, about 50 nm, about 52 nm, about 54 nm, about 56 nm, about 58 nm, about 60 nm, about 62 nm, about 64 nm, about 66 nm, about 68 nm, about 70 nm, about 72 nm, about 74 nm, about 76 nm, about 78 nm, about 80 nm, about 82 nm, about 84 nm, about 86 nm, about 88 nm, about 90 nm, about 92 nm, about 94 nm, about 96 nm, about 98 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, and about 400 nm.

In some embodiments, the resulting single layer, self-adhesive fibrous medium (506, 520, 526, or 528) may be removed from the substrate 504. The resulting single layer, self-adhesive fibrous medium (506, 520, 526, or 528) may be further transferred to another substrate (such as a non-conducting substrate) or surface, in some embodiments.

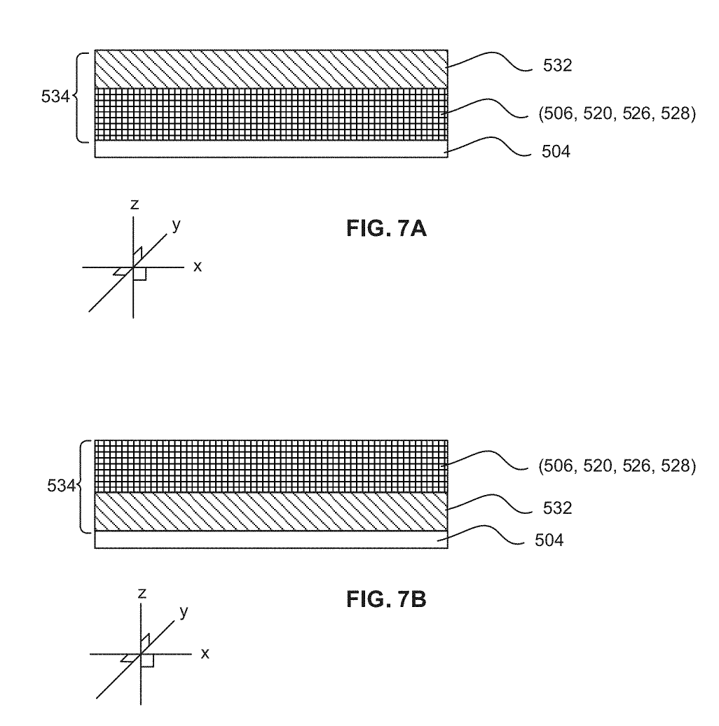

In some embodiments, the system 500 may further comprise at least another extrusion element (e.g., such as of a similar type of extrusion element 102) configured to optionally extrude an additional material to form a second layer 530. This second layer 532 may be formed above or on the single layer 506, 520 comprising the dual component adhesive fibers, or above or on the single layer 526, 528 comprising the multicomponent adhesive fibers, as shown in FIG. 7A.

In some embodiments, the order of the layers shown in FIG. 7A may be reversed. For instance, as shown in FIG. 7B, the at least another extrusion element may be configured to optionally form the second layer 532 on the substrate 504, followed by formation of the single layer 506, 520 comprising the dual component adhesive fibers, or the single layer 526, 528 comprising the multicomponent adhesive fibers, above or on the second layer 532. In some embodiments, the second layer 532 may comprise a non-woven structure, a woven structure, a mesh structure, or a membrane.

In some embodiments, the second layer 532 may comprise one or more similar properties (e.g., basis weight, average fiber diameter, etc.) as that of the respective single layer (506, 520, 526, or 528). In some embodiments, the second layer 532 may comprise one or more different properties (e.g., basis weight, average fiber diameter, etc.) as that of the respective single layer (506, 520, 526, or 528).

In some embodiments, the second layer 532 may comprise one or more similar polymer materials as the respective single layer (506, 520, 526, or 528). In some embodiments, the second layer 532 may comprise one or more different polymer materials as that of the single layers (506, 520, 526, or 528).

In some embodiments, the resulting dual-layer, self-adhesive fibrous medium 534 may be removed from the substrate 504, where said substrate may then be used in additional fiber forming processes.

With continued reference to FIGS. 5A-5H, the system 500 may comprise, in some embodiments, a single extrusion element 502, e.g., a single extrusion element 502a configured to extrude a dual component (“sheath-core”) adhesive fiber, a single extrusion element 502b configured to extrude an “island-in-sea” type dual component adhesive fiber, a single extrusion element 502c configured to extrude a multicomponent (“coaxial”) adhesive fiber, or a single extrusion element 502d configured to extrude an “island-in-sea” type (“coaxial”) multicomponent adhesive fiber. See, e.g., FIG. 3A for an exemplary schematic of a system comprising a single type of extrusion element.

In some embodiments, the system 500 may comprise a plurality of extrusion elements 502, where each extrusion element 502 is independently an extrusion element 502a configured to extrude a dual component (“sheath-core”) adhesive fiber, an extrusion element 502b configured to extrude an “island-in-sea” type dual component adhesive fiber, an extrusion element 502c configured to extrude a multicomponent (“coaxial”) adhesive fiber, or an extrusion element 502d configured to extrude an “island-in-sea” type multicomponent (“coaxial”) adhesive fiber. In some embodiments, the system 500 may comprise a plurality of extrusion elements, where each extrusion element is of the same type (e.g., extrusion element 502a, extrusion element 502b, extrusion element 502c, or extrusion element 502d). See, e.g., FIG. 3B for an exemplary schematic of a system comprising a plurality of extrusion elements.

In some embodiments, the system 100 may comprise at least two, at least three, at least four, etc. sets/groups of extrusion elements 502, where each set/group may independently comprises at least two extrusion elements 502, and where at least one of said sets/groups comprises a different type of extrusion element (e.g., extrusion element 502a, extrusion element 502b, extrusion element 502c, or extrusion element 502d) as compared to the type of extrusion elements of at least another of said set/groups. In some embodiment, at least two of said sets/groups may comprise the same type of extrusion element (e.g., extrusion element 502a, extrusion element 502b, extrusion element 502c, or extrusion element 502d), whereas at least another of said sets/groups may comprise a different type extrusion element. In some embodiments, at least one of said sets/groups may comprise an extrusion element (e.g., similar to extrusion element 102) configured to extrude the third or additional materials, as described herein. See, e.g., FIG. 3C for an exemplary schematic of a system comprising at least four sets/groups of extrusion elements.

In embodiments in which the system 500 comprises a single extrusion element 502 or a plurality of extrusion elements 502, the system 500 may comprise a scaffold that is coupled to, and supports, the extrusion element(s) 502. In some embodiments, such scaffold may comprise any of the shapes, dimensions, and properties as described herein.

c. System for Two-Step Formation of Self-Adhesive Fibrous Media Comprising Dual or Multicomponent Adhesive Fibers

Referring now to FIGS. 8A-8B, cross-sectional, side views of a system 800 for forming a self-adhesive fibrous medium comprising dual or multicomponent adhesive fibers is shown in accordance with one embodiment. The system 800 or components/features thereof may be implemented in combination with, or as an alternative to, other devices/features/components described herein, such as those described with reference to other embodiments and FIGS. The system 800 may additionally be utilized in any of the methods for making and/or using such devices/components/features described herein. The system 800 may also be used in various applications and/or in permutations, which may or may not be noted in the illustrative embodiments described herein. For instance, the electrospray system 800 may include more or less features/components than those shown in FIGS. 8A-8B, in some embodiments. Moreover, the system 800 is not limited to the size, shape, number of components, etc. specifically shown in FIGS. 8A-8B.

In some embodiments, the system 800 may be configured to form a self-adhesive fibrous medium comprising dual component or multicomponent fibers via a one-step process, described in detail below. Moreover, as the system 800 is a variation, and particularly combines elements, of system 100 of FIGS. 1A-1D and system 500 of FIGS. 5A-5H, like components and features are assigned the same reference number.

As particularly shown in FIG. 8A, the system 800 may comprise at least one extrusion element 102 (as described, e.g., with reference system 100 of FIGS. 1A-1D) configured to deliver a first material, which is extruded in the form of a first plurality of fibers 802. The first plurality of fibers 802 travels, or is drawn, toward the substrate 804 to form a first layer 806 (e.g., a fibrous web) thereupon.

In some embodiments, the first layer 806 may be formed via a spunbonding process, a melt-blown process, an air-laid process, a wet-laid process, a needle-punching process, a spunlacing process, an electrospinning (or electrospraying) process, and combinations thereof. In some embodiments, the first layer 804 may be formed via a spunbonding process, a melt-blown process, an electrospinning (or electrospraying), or combinations thereof. In some embodiments, the first layer 804 may be formed via an air-laid process, a wet-laid process, a spun-lacing (hydro-entangling) process, a needle-punching process, process, or combinations thereof. In some embodiments, the first layer 806 may be formed via a spunbonding process. In some embodiments, the first layer 804 may be formed via a melt-blown process. In some embodiments, the first layer 806 may be formed via an air-laid process. In some embodiments, the first layer 806 may be formed via a wet-laid process. In some embodiments, the first layer 806 may be formed via a needle-punching process. In some embodiments, the first layer 806 may be formed via a spun-lacing process. In some embodiments, the first layer 806 may be at least partially or completely formed via an electrospinning (or electrospraying) process, as described herein. In some embodiments, such electrospinning (or electrospraying) process may be a top-down process (see, e.g., FIG. 2A); a bottom-up process (see, e.g., FIG. 2B); or a vertical process (see, e.g., FIG. 2C).

With continued reference to FIG. 8A, the first plurality of fibers 802 in the first layer 806 may have a basis weight in a range from about 0.1 g/m² to about 1,000 g/m², about 0.1 g/m² to about 500 g/m², about 0.5 g/m² to about 100 g/m², about 0.5 g/m² to about 50 g/m², or about 1 g/m² to about 10 g/m², in some embodiments. In some embodiments, the first plurality of fibers 802 in the first layer 806 may have a basis weight in a range between and including any two of the following: about 1 g/m², about 1.2 g/m², about 1.4 g/m², about 1.6 g/m², about 1.8 g/m², about 2 g/m², about 2.2 g/m², about 2.4 g/m², about 2.6 g/m², about 2.8 g/m², about 3 g/m², about 3.2 g/m², about 3.4 g/m², about 3.6 g/m², about 3.8 g/m², about 4 g/m², about 4.2 g/m², about 4.4 g/m², about 4.6 g/m², about 4.8 g/m², about 5 g/m², about 5.2 g/m², about 5.4 g/m², about 5.6 g/m², about 5.8 g/m², about 6 g/m², about 6.2 g/m², about 6.4 g/m², about 6.6 g/m², about 6.8 g/m², about 7 g/m², about 7.2 g/m², about 7.4 g/m², about 7.6 g/m², about 7.8 g/m², about 8 g/m², about 8.2 g/m², about 8.4 g/m², about 8.6 g/m², about 8.8 g/m², about 9 g/m², about 9.2 g/m², about 9.4 g/m², about 9.6 g/m², about 9.8 g/m², and about 10 g/m².

In some embodiments, the first plurality of fibers 802 in the first layer 806 may have an average diameter in a range from about 10 nm to about 100 μm, about 10 nm to about 1 μm, about 10 nm to about 500 nm, or about 30 nm to about 400 nm. In some embodiments, the first plurality of fibers 802 in the first layer 806 may have an average diameter in a range between and including any two of the following: about 30 nm, about 32 nm, about 34 nm, about 36 nm, about 38 nm, about 40 nm, about 42 nm, about 44 nm, about 46 nm, about 48 nm, about 50 nm, about 52 nm, about 54 nm, about 56 nm, about 58 nm, about 60 nm, about 62 nm, about 64 nm, about 66 nm, about 68 nm, about 70 nm, about 72 nm, about 74 nm, about 76 nm, about 78 nm, about 80 nm, about 82 nm, about 84 nm, about 86 nm, about 88 nm, about 90 nm, about 92 nm, about 94 nm, about 96 nm, about 98 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, and about 400 nm.

In some embodiments, exemplary materials for use in formation of the first plurality of fibers 802 of the first layer 806 may include, but are not limited to, polypropylene, polyethylene, poly(ethylene oxide), polyethylene terephthalate, nylon, polyvinyl alcohol, polyvinylpyrrolidone, polyvinylidene fluoride, polystyrene, polypropylene, polyethylene, poly(ethylene oxide), polyethylene terephthalate, polyacrylonitrile, polyimide, polyvinyl chloride, polycarbonate, polyurethane, polysulfone, polyactic acid, polytetrafluoroethylene, polybenzoxazoles, poly-aramid, poly(phenylene sulfide), poly-phenylene terephthalamide, polytetrafluoroethylene, and combinations thereof.

As particularly shown in FIG. 8B, the system 800 additionally comprises at least one extrusion element 502 (as described, e.g., with reference to system 500 of FIGS. 5A-5H) configured to deliver dual or multicomponent adhesive fibers 808 as described herein. For instance, in some embodiments, the system 800 may comprise one or more extrusion elements 502, where each extrusion element 502 is independently selected from an: extrusion element 502a configured to extrude a dual component (“sheath-core”) adhesive fiber as described herein; extrusion element 502b configured to extrude an “island-in-sea” type dual component adhesive fiber as described herein; extrusion element 502c configured to extrude a multicomponent “co-axial” adhesive fiber as described herein; and extrusion element 502d configured to extrude an “island-in-sea” type multicomponent (“co-axial”) adhesive fiber as described herein. The dual and/or multicomponent adhesive fibers 810 extruded from the respective extrusion element 502 may travel, or be drawn, toward the substrate 804 to form a second layer 810 above, or on, the first layer 806.

In some embodiments, the dual and/or multicomponent adhesive fibers 808 of the second layer 810 may be at least partially or completely formed via an electrospinning (or electrospraying) process, as described herein. In some embodiments, such electrospinning (or electrospraying) process may be a top-down process (see, e.g., FIG. 2A); a bottom-up process (see, e.g., FIG. 2B); or a vertical process (see, e.g., FIG. 2C).

With continued reference to FIG. 8B, the second layer 810 may have a basis weight in a range from about 0.1 g/m² to about 1,000 g/m², about 0.1 g/m² to about 500 g/m², about 0.5 g/m² to about 100 g/m², about 0.5 g/m² to about 50 g/m², or about 1 g/m² to about 10 g/m², in some embodiments. In some embodiments, the second layer 810 may have a basis weight in a range between and including any two of the following: about 1 g/m², about 1.2 g/m², about 1.4 g/m², about 1.6 g/m², about 1.8 g/m², about 2 g/m², about 2.2 g/m², about 2.4 g/m², about 2.6 g/m², about 2.8 g/m², about 3 g/m², about 3.2 g/m², about 3.4 g/m², about 3.6 g/m², about 3.8 g/m², about 4 g/m², about 4.2 g/m², about 4.4 g/m², about 4.6 g/m², about 4.8 g/m², about 5 g/m², about 5.2 g/m², about 5.4 g/m², about 5.6 g/m², about 5.8 g/m², about 6 g/m², about 6.2 g/m², about 6.4 g/m², about 6.6 g/m², about 6.8 g/m², about 7 g/m², about 7.2 g/m², about 7.4 g/m², about 7.6 g/m², about 7.8 g/m², about 8 g/m², about 8.2 g/m², about 8.4 g/m², about 8.6 g/m², about 8.8 g/m², about 9 g/m², about 9.2 g/m², about 9.4 g/m², about 9.6 g/m², about 9.8 g/m², and about 10 g/m².

In some embodiments, the second layer 810 may have an average fiber diameter in a range from about 10 nm to about 100 μm, about 10 nm to about 1 μm, about 10 nm to about 500 nm, or about 30 nm to 400 nm. In some embodiments, the second layer 810 may have an average diameter in a range between and including any two of the following: about 30 nm, about 32 nm, about 34 nm, about 36 nm, about 38 nm, about 40 nm, about 42 nm, about 44 nm, about 46 nm, about 48 nm, about 50 nm, about 52 nm, about 54 nm, about 56 nm, about 58 nm, about 60 nm, about 62 nm, about 64 nm, about 66 nm, about 68 nm, about 70 nm, about 72 nm, about 74 nm, about 76 nm, about 78 nm, about 80 nm, about 82 nm, about 84 nm, about 86 nm, about 88 nm, about 90 nm, about 92 nm, about 94 nm, about 96 nm, about 98 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, and about 400 nm.

In some embodiments, the dual component and/or multicomponent adhesive fibers 808 of the second layer 810 may comprise at least one adhesive polymer material. For instance, in embodiments in which the second layer 810 comprises at least dual component adhesive fibers, each dual component adhesive fiber may comprise an outer region substantially surrounding one or more inner regions, where the outer region comprises an adhesive polymer material as described herein, and each of the inner regions independently comprise an adhesive or non-adhesive polymer material as described herein. In embodiments in which the second layer 810 comprises at least multicomponent adhesive fibers, each multicomponent adhesive fiber may comprise an outer region substantially surrounding one or more inner regions, where the outer region comprises an adhesive polymer material as described herein, and each of the inner regions independently comprise at least two materials (each of which is an adhesive or non-adhesive polymer material as described herein).

In some embodiments, the resulting dual layer, self-adhesive fibrous medium 812 comprising dual and/or multicomponent adhesive fibers, as shown, e.g., in FIG. 8B, may be removed from the substrate 804, where said substrate may be further used in another fiber forming process. The resulting single layer, self-adhesive fibrous medium 812 may be further transferred to another substrate (such as a non-conducting substrate) or surface, in some embodiments.

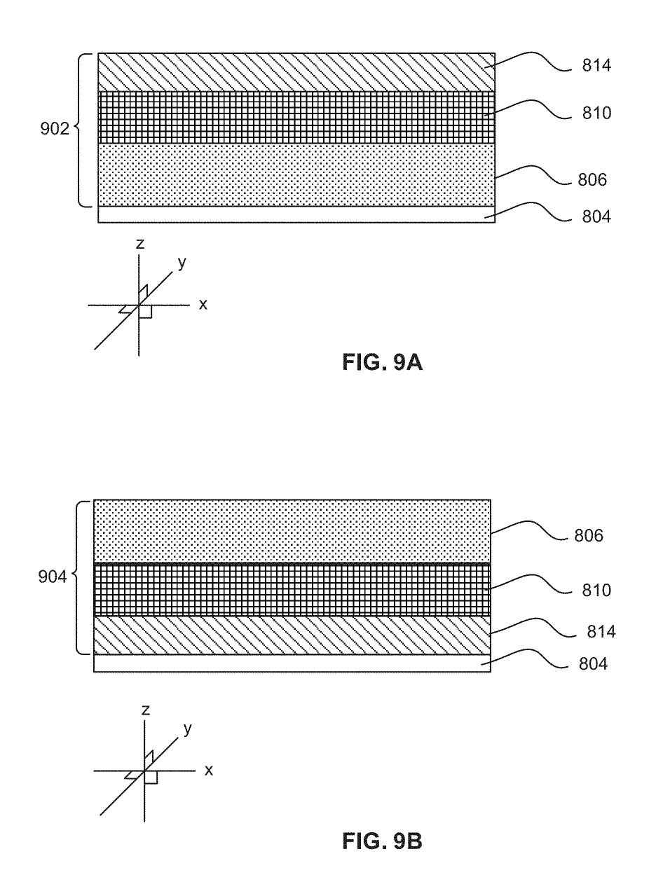

In some embodiments, the system 800 may be configured to extrude a third material toward the substrate 804 to form a third layer 814 above or on the second layer 810, where the resulting tri-layer self-adhesive medium 902 is shown in FIG. 9A. In some embodiments, the first and third materials may be extruded (in a sequential fashion) from the same extrusion element 102. In such an embodiment, a first surface 106 of the at least one extrusion element 102 may thus be in fluid communication with both the source of the first material and the source of the third material. In some embodiments, the system 800 may comprise two or more extrusion elements 102, where at least one of the extrusion elements 102 may be configured to extrude the first material, and at least another of the extrusion elements 102 may be configured to extrude the third material.

In some embodiments, the order of the layers shown in FIG. 9A may be reversed. For instance, in some embodiments, the system 800 may be configured to form the third layer 814 on the substrate 804, the second layer 810 above or on the third layer 814, and the first layer 806 above or on the second layer 810, thereby resulting in the tri-layer self-adhesive medium 904 of FIG. 9B.

In some embodiments, the third layer 814 may comprise a non-woven structure, a woven structure, a mesh structure, or a membrane.

In some embodiments, the third layer 814 may comprise one or more similar properties (e.g., basis weight, average fiber diameter, etc.) as that of the first layer 806 and/or the second layer 810. In some embodiments, the third layer 814 may comprise one or more different properties (e.g., basis weight, average fiber diameter, etc.) as that of the first layer 806 and/or the second layer 810.

In some embodiments, the third layer 814 may comprise one or more similar polymer materials as that of the first layer 806 and/or the second layer 810. In some embodiments, the third layer 914 may comprise one or more different polymer materials as that of the first layer 806 and/or the second layer 810.

In some embodiments, the resulting tri-layer, self-adhesive fibrous medium (see, e.g., 902 or 904 of FIGS. 9A-9B) may be removed from the substrate 804, where said substrate may then be used in additional fiber forming processes.

d. Customizable Systems

One advantage of the systems described herein is the degree of customizability of each of the components thereof. For instance, in some embodiments, one such system may comprise a scaffold that is coupled to, and supports, one or more extrusion element(s). The shape and size of the scaffold may be customized, as well as the pattern/arrangement of the extrusion elements coupled thereto. Further, each pore extrusion element may be individually/independently customized at least with respect to: shape, size, and the type of extrusion element (e.g., extrusion element 102 of FIGS. 1A-1D, extrusion element 502a of FIGS. 5A-5B, extrusion element 502b of FIGS. 5C-5D, extrusion element 502c of FIGS. 5E-5F, extrusion element 502d of FIGS. 5G-5H, etc.).

For instance, in some embodiments, the scaffold may comprise one or more of the following:
i) at least one extrusion element 102 as described, e.g., in FIGS. 1A-1D, and which is configured to extrude a first material for formation of a first plurality of fibers 112;
ii) at least one extrusion element 102 as described, e.g., in FIGS. 1A-1D, and which is configured to extrude a second material for formation of second plurality of adhesive fibers 116;
iii) at least one extrusion element 102 as described, e.g., in FIGS. 1A-1D, and which is configured to extrude a third material for formation of a third plurality of fibers;
iv) at least one extrusion element 502a as described, e.g., in FIGS. 5A-5B, and which is configured to form dual component (“sheath-core”) adhesive fibers;
v) at least one extrusion element 502b as described, e.g., in FIGS. 5C-5D, and which is configured to form “islands-in-sea” type dual component adhesive fibers;
vi) at least one extrusion element 502c as described, e.g., in FIGS. 5E-5F, and which is configured to form multicomponent (“coaxial”) adhesive fibers; and/or
vii) at least one extrusion element 502d as described, e.g., in FIGS. 5G-5H, and which is configured to form “islands-in-sea” type multicomponent adhesive fibers.

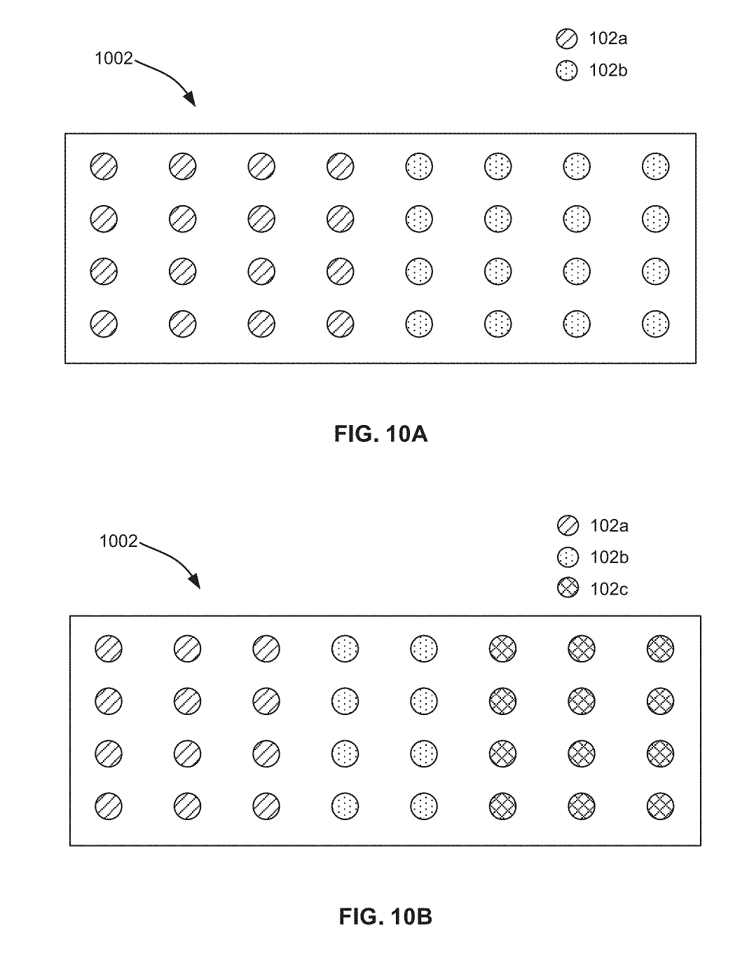

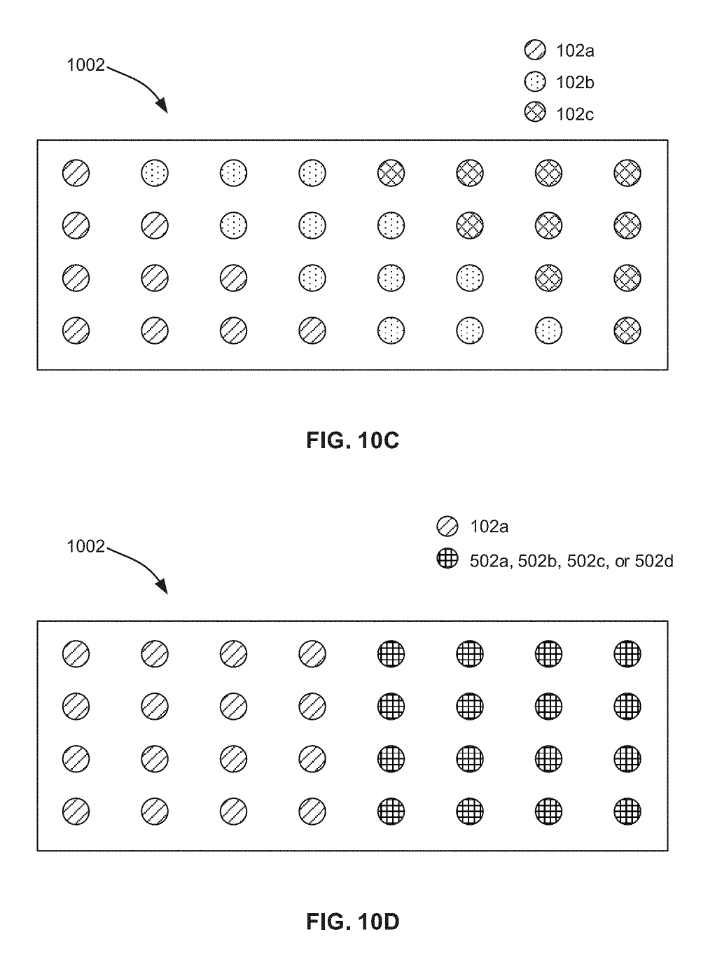

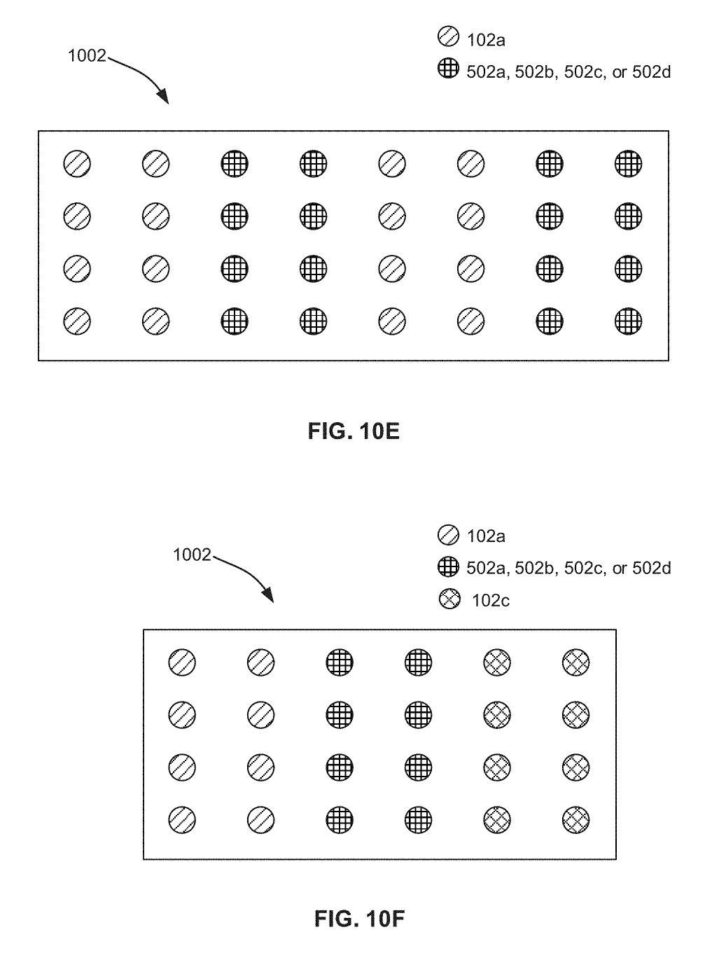

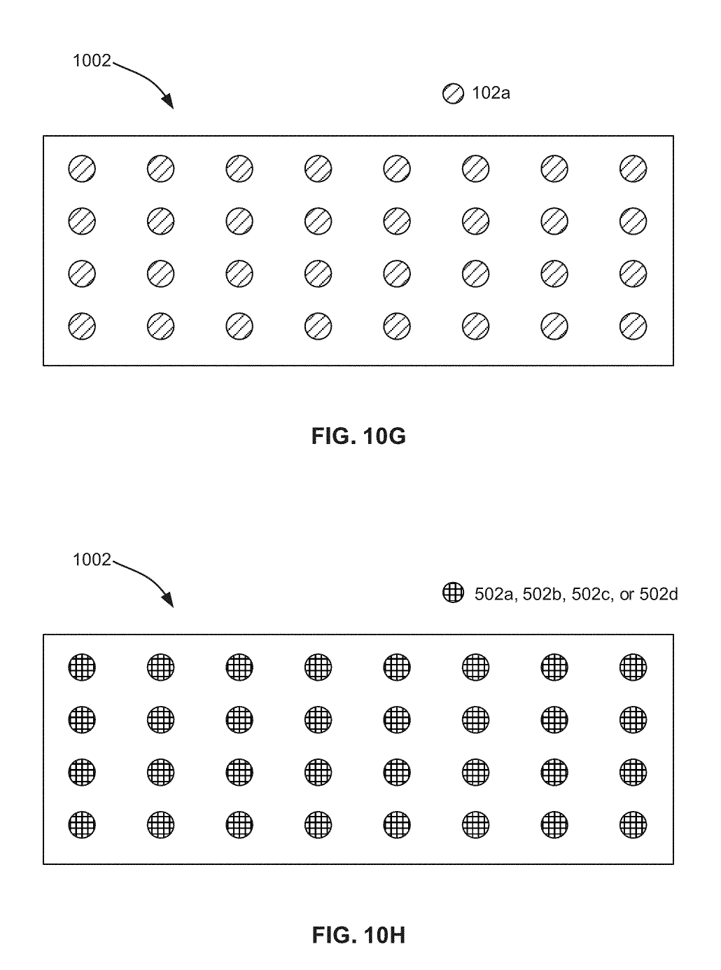

FIGS. 10A-10H provide top-down views of scaffolds comprising different types of extrusion elements, according to various embodiments. For instance, FIG. 10A provides an illustrative embodiment in which a scaffold 1002 comprises: a first plurality of extrusion elements 102a each configured to extrude a first material for formation of a first plurality of fibers 112; and a second plurality of extrusion elements 102b each configured to extrude a second material for formation of a second plurality of adhesive fibers 116.

FIGS. 10B-10C provide illustrative embodiments in which the scaffold 1002 comprises: a first plurality of extrusion elements 102a each configured to extrude a first material for formation of a first plurality of fibers 112; a second plurality of extrusion elements 102b each configured to extrude a second material for formation of a second plurality of adhesive fibers 116; and a third plurality of extrusion elements 102c each configured to extrude a third material for formation of a third plurality of fibers.

FIGS. 10D-10E provide illustrative embodiments in which the scaffold 1002 comprises: a first plurality of extrusion elements 102a each configured to extrude a first material for formation of a first plurality of fibers 112; and a second plurality of extrusion elements 502a, 502b, 502c, or 502c each configured to form dual component (“sheath-core”) adhesive fibers, “islands-in-sea” type dual component adhesive fibers, multicomponent (“coaxial”) adhesive fibers, or “islands-in-sea” type multicomponent adhesive fibers, respectively.

FIG. 10F provides an illustrative embodiment in which the scaffold 1002 comprises: a first plurality of extrusion elements 102a each configured to extrude a first material for formation of a first plurality of fibers 112; a second plurality of extrusion elements 502a, 502b, 502c, or 502c each configured to form dual component (“sheath-core”) adhesive fibers, “islands-in-sea” type dual component adhesive fibers, multicomponent (“coaxial”) adhesive fibers, or “islands-in-sea” type multicomponent adhesive fibers, respectively; and a third plurality of extrusion elements 102c each configured to extrude a third material for formation of a third plurality of fibers.

FIGS. 10G-10H provide top-down views of scaffolds comprising a plurality of the same type of extrusion elements, according to various embodiments. For instance, FIG. 10G provides an illustrative embodiment in which the scaffold 1002 comprises a plurality of extrusions elements 102 configured to extrude both the first material and the second material in a sequential fashion, as described herein. FIG. 10H provides an illustrative embodiment in which the scaffold 1002 comprises a plurality of extrusion elements 502a, 502b, 502c, or 502c each configured to form dual component (“sheath-core”) adhesive fibers, “islands-in-sea” type dual component adhesive fibers, multicomponent (“coaxial”) adhesive fibers, or “islands-in-sea” type multicomponent adhesive fibers, respectively.

It is of note that the number and/or arrangement of the extrusion elements in FIGS. 10A-10H is merely exemplary. For instance, the number and arrangement of the extrusion elements may tailored as desired or as required by certain applications.

### 2. METHODS

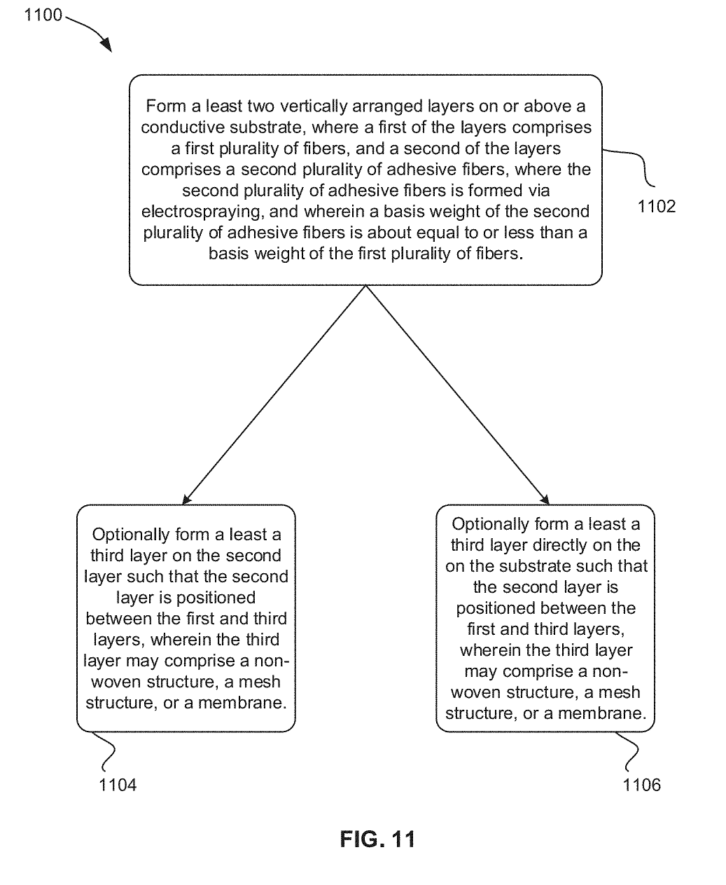

Referring now to FIG. 11, a flowchart of an exemplary method 1100 for forming a self-adhesive, dual or multilayer fibrous medium is shown according to one embodiment. The method 1100 may be implemented in conjunction with any of the features/components described herein, such as those described with reference to other embodiments and FIGS. The method 1100 may also be used for various applications and/or according to various permutations, which may or may not be noted in the illustrative embodiments/aspects described herein. For instance, the method 1100 may include more or less operations/steps than those shown in FIG. 11, in some embodiments. Moreover, the method 1100 is not limited by the order of operations/steps shown therein.

As shown in FIG. 11, the method 1100 comprises forming at least two vertically arranged layers on a substrate, where a first of the layers comprises a first plurality of fibers, and a second of the layers comprises a second plurality of adhesive fibers, the second plurality of adhesive fibers is formed via electrospraying, and a basis weight of the second plurality of adhesive fibers is about equal to or less than a basis weight of the first plurality of fibers. See Step 1102.

In some embodiments, the basis weight of the second plurality of adhesive fibers is less than the basis weight of the first plurality of fibers. In some embodiments, the basis weight of the second plurality of adhesive fibers is in a range from about 0.1 g/m² to about 10 g/m². In some embodiments, the basis weight of the first plurality of fibers is in a range from about 1 g/m² to about 1000 g/m².

In some embodiments, an average diameter of the second plurality of adhesive fibers is about equal to or less than an average diameter of the first plurality of fibers. In some embodiments, an average diameter of the second plurality of adhesive fibers is greater than an average diameter of the first plurality of fibers. In some embodiments, each of the second plurality of adhesive fibers independently comprises a diameter in a range from about 10 nm to about 10 μm. In some embodiments, each of the first plurality of fibers independently comprises a diameter in a range from about 30 nm to about 400 μm.

In some embodiments, the first layer is formed directly on the substrate. In some embodiments, at least a third layer is optionally formed on the second layer such that the second layer is positioned between the first and third layers, wherein the third layer comprises a non-woven structure, a mesh structure, a woven structure, or a membrane. See Step 1104.

In some embodiments, at least a third layer is optionally formed directly on the substrate such that the second layer is positioned between the third and first layers, wherein the third layer comprises a non-woven structure, a mesh structure, a woven structure, or a membrane. See Step 1106.

In some embodiments, the first layer is formed via a spunbonding process, a melt-blown process, an air-laid process, a wet-laid process, a needle-punching process, a spun-lacing process, an electro-spinning process, and combinations thereof.

In some embodiments, each of the second plurality of adhesive fibers independently comprises a pressure sensitive adhesive polymer, a light sensitive adhesive polymer, a hot-melt adhesive polymer, and combinations thereof.

In some embodiments, each of the second plurality of adhesive fibers independently comprises an adhesive polymer material or a composition thereof, wherein the adhesive polymer material is selected from ethylene-vinyl acetate (EVA), polyolefins (PO), polyamides (PA), polyester, polyurethane (PU), an acrylic, bio-based acrylate, butyl rubber, nitriles, silicone rubber, styrene butadiene rubber, natural rubber latex, and combinations thereof.

In some embodiments, one or more of the second plurality of adhesive fibers are dual component adhesive fibers comprising two different polymer materials, provided one of the polymer materials is adhesive. In some embodiments, each of the dual component adhesive fibers comprises an outer region substantially surrounding one or more inner regions, wherein the outer region comprises a first adhesive polymer material, and the one or more inner regions independently comprise a second adhesive polymer material or a non-adhesive polymer material.

In some embodiments, one or more of the second plurality of adhesive fibers are multi-component adhesive fibers comprising at least three different polymer materials, provided one of the polymer materials is adhesive. In some embodiments, each of the multi-component adhesive fibers comprises an outer region substantially surrounding one or more inner regions, wherein the outer region comprises a first adhesive polymer material, and each of the one or more inner regions comprises at least two polymer materials independently selected from a second adhesive polymer material and a non-adhesive polymer material.

In some embodiments, at least a portion of the second plurality of adhesive fibers are not substantially aligned in a parallel alignment. For instance, in some embodiments, at least a portion of the second plurality of adhesive fibers may not be oriented in a parallel arrangement (e.g. the longitudinal axes of each of the second plurality of adhesive fibers in said portion of adhesive fibers may be not be oriented parallel to one another). In some embodiments, at least a majority or substantially all (e.g., at least about 80%, at least about 85%, at least about 90%, at least about 95%, at least about 98%, at least about 99%, etc.) of the second plurality of adhesive fibers may not be oriented in a parallel arrangement.

In some embodiments, the substrate is conductive. In some embodiments associated with the methods and/or systems disclosed herein, the substrate is non-conductive.

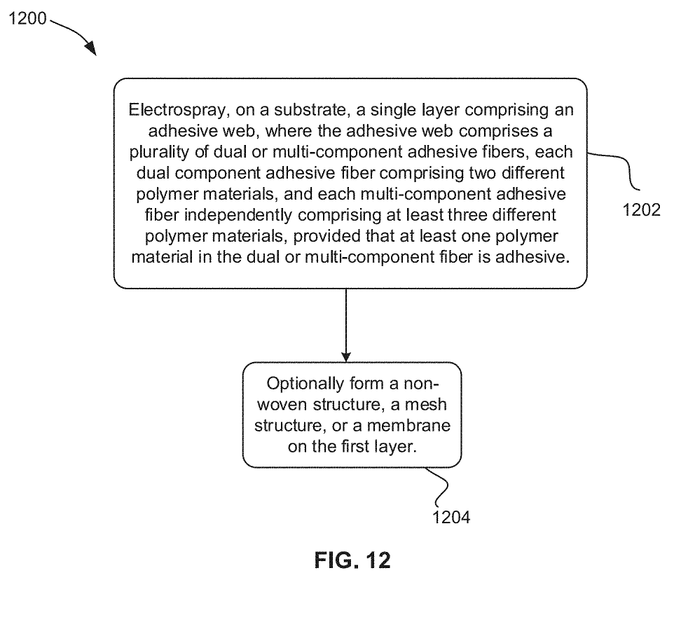

Referring now to FIG. 12, a flowchart of an exemplary method 1200 for forming a self-adhesive, single layer fibrous medium is shown according to one embodiment. The method 1200 may be implemented in conjunction with any of the features/components described herein, such as those described with reference to other embodiments and FIGS. The method 1200 may also be used for various applications and/or according to various permutations, which may or may not be noted in the illustrative embodiments/aspects described herein. For instance, the method 1200 may include more or less operations/steps than those shown in FIG. 12, in some embodiments. Moreover, the method 1200 is not limited by the order of operations/steps shown therein.

As shown in FIG. 12, the method 1200 comprises electrospraying, on a substrate, a single layer comprising an adhesive web, where the adhesive web comprises a plurality of dual or multi-component adhesive fibers, each dual component adhesive fiber comprising two different polymer materials, and each multi-component adhesive fiber independently comprising at least three different polymer materials, provided that at least one polymer material in the dual or multi-component fiber is adhesive. See Step 1202.

In some embodiments, the adhesive web has a basis weight in a range from about 0.1 g/m² to about 1000 g/m².

In some embodiments, each dual or multi-component adhesive fiber independently comprises a diameter in a range from about 10 nm to about 10 μm.

In some embodiments, a non-woven structure, a mesh structure, a woven structure, or a membrane is optionally formed on the first layer. See Step 1204.

In some embodiments, each dual component adhesive fiber comprises an outer region substantially surrounding one or more inner regions, wherein the outer region comprises a first adhesive polymer material, and each of the one or more inner regions comprises a second adhesive polymer material or a non-adhesive polymer material.

In some embodiments, each multi-component adhesive fiber comprises an outer region substantially surrounding one or more inner regions, wherein the outer region comprises a first adhesive polymer material, and each of the one or more inner regions comprises at least two polymer materials independently selected from a second adhesive polymer material and a non-adhesive polymer material.

### 3. EXAMPLES

Scanning electron microscope (SEM) images of exemplary nanometer or sub-micron adhesive fibrous webs produced by the methods described herein are shown in FIGS. 13A-13D and FIGS. 14A-14D. For instance, FIGS. 13A-13B provide views of the adhesive web 1302 above the fibrous layer(s) 1304, where the adhesive web comprises a plurality of adhesive fibers having an average diameter of about 1 to 2 μm. FIGS. 13C-13D provide different views in which the adhesive web 1302 is below (under) the fibrous layer(s) 1304.

FIGS. 14A-14B provide views of the adhesive web 1402 below (under) the fibrous layer(s) 1404, where the adhesive web comprises a plurality of adhesive fibers having an average diameter of about 300 nm.

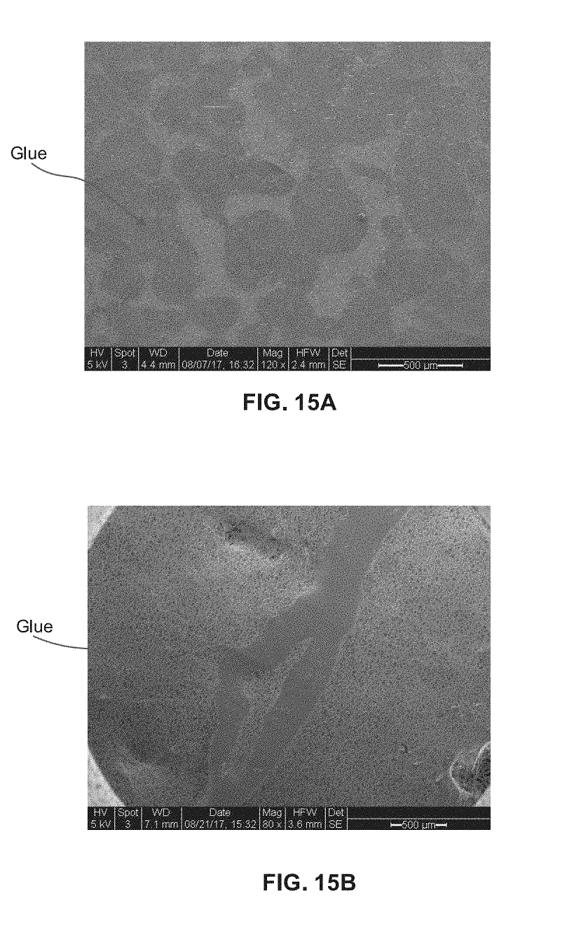

As discussed previously, the nanometer or sub-micron adhesive webs shown, e.g., in FIGS. 13A-13D and FIGS. 14A-14B, provide fine fiber-like gluing spots for the fibrous layer(s) in contact therewith. In contrast, FIGS. 15A-15B provide SEM images of adhesive systems produced via conventional roller and gun gluing systems, respectively, which lack the fine fiber-like gluing spots observed in the nanometer or sub-micron adhesive fibrous webs described herein.

Unless otherwise defined, all technical and scientific terms used herein have the same meaning as commonly understood by one of ordinary skill in the art to which this invention belongs.

Throughout the present specification and claims, unless the context requires otherwise, the word “comprise” and variations thereof (e.g., “comprises” and “comprising”) are to be construed in an open, inclusive sense, that is as “including, but not limited to.” Additionally, the singular forms “a,” “an” and “the” include plural referents unless the context clearly dictates otherwise.

Recitation of numeric ranges of values throughout the specification is intended to serve as a shorthand notation of referring individually to each separate value falling within the range inclusive of the values defining the range, and each separate value is incorporated in the specification as it were individually recited herein.

Reference to “about” a value or parameter herein includes (and describes) embodiments that are directed to that value or parameter per se. In some embodiments, the term “about” includes the indicated amount ±10%.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

The invention described and claimed herein is not to be limited in scope by the specific embodiments disclosed herein, as these embodiments are intended as illustrations of several aspects of the invention. Indeed, various modifications of the invention in addition to those shown and described herein will become apparent to those skilled in the art from the foregoing description. Such modifications include the substitution of known equivalents for any aspect of the invention in order to achieve the same result in substantially the same way. Such modifications are also intended to fall within the scope of the appended claims.

What is claimed is:

1. A method of forming a self-adhesive, dual or multilayer fibrous medium, the method comprising:
forming at least two vertically arranged layers on or above a substrate,
wherein a first of the layers comprises a first plurality of fibers, and a second of the layers comprises a second plurality of adhesive fibers,
wherein the second plurality of adhesive fibers is formed via electrospraying, and
wherein a basis weight of the second plurality of adhesive fibers is about equal to or less than a basis weight of the first plurality of fibers.

2. The method of claim 1, wherein the basis weight of the second plurality of adhesive fibers is in a range from about 0.1 g/m² to about 10 g/m².

3. The method of claim 2, wherein the basis weight of the first plurality of fibers is in a range from about 1 g/m² to about 1000 g/m².

4. The method of claim 1, wherein each of the second plurality of adhesive fibers independently comprises a diameter in a range from about 10 nm to about 10 μm.

5. The method of claim 1, wherein the first layer is formed directly on the substrate.

6. The method of claim 1, further comprising forming at least a third layer on the second layer such that the second layer is positioned between the first and third layers, wherein the third layer comprises a non-woven structure, a mesh structure, a woven structure, or a membrane.

7. The method of claim 1, wherein the first layer is formed via a spunbonding process, a melt-blown process, an air-laid process, a wet-laid process, an electro-spinning process, or a spun-lacing process, a needle punching process, or combinations thereof.

8. The method of claim 1, wherein each of the second plurality of adhesive fibers independently comprises a pressure sensitive adhesive polymer, a light sensitive adhesive polymer, a hot-melt adhesive polymer, and combinations thereof.

9. The method of claim 1, wherein each of the second plurality of adhesive fibers independently comprises an adhesive polymer material or a composition thereof, wherein the adhesive polymer material is selected from ethylene-vinyl acetate (EVA), polyolefins (PO), polyamides (PA), polyester, polyurethane (PU), an acrylic, bio-based acrylate, butyl rubber, nitriles, silicone rubber, styrene butadiene rubber, natural rubber latex, and combinations thereof.

10. The method of claim 1, where one or more of the second plurality of adhesive fibers are dual component adhesive fibers comprising two different polymer materials, provided one of the polymer materials is adhesive.

11. The method of claim 10, wherein each of the dual component adhesive fibers comprises an outer region substantially surrounding one or more inner regions, wherein the outer region comprises a first adhesive polymer material, and the one or more inner regions independently comprise a second adhesive polymer material or a non-adhesive polymer material.

12. The method of claim 1, wherein at least a portion of the second plurality of adhesive fibers are not substantially aligned in a parallel alignment.

13. A method of forming a self-adhesive, single layer fibrous medium, the method comprising:
electrospraying, on or above a substrate, a single layer comprising an adhesive web,
wherein the adhesive web comprises a plurality of dual or multi-component adhesive fibers, each dual component adhesive fiber comprising two different polymer materials, and each multi-component adhesive fiber independently comprising at least three different polymer materials, provided that at least one polymer material in the dual or multi-component fiber is adhesive.

14. The method of claim 13, wherein the adhesive web has a basis weight in a range from about 0.1 g/m² to about 1000 g/m².

15. The method of claim 13, wherein each dual or multi-component adhesive fiber independently comprises a diameter in a range from about 10 nm to about 10 μm.

16. The method of claim 13, further comprising forming a non-woven structure, a mesh structure, a woven structure, or a membrane on the first layer.

17. The method of claim 13, wherein each dual component adhesive fiber comprises an outer region substantially surrounding one or more inner regions, wherein the outer region comprises a first adhesive polymer material, and each of the one or more inner regions comprises a second adhesive polymer material or a non-adhesive polymer material.

18. An electrospray system for forming a self-adhesive fibrous medium, the system comprising:
a substrate, and
at least one extrusion element in spaced relation with the substrate, the at least one extrusion element configured to deliver a first material and a second, adhesive material;
wherein the substrate and the at least one extrusion element are configured to form an electric field therebetween to cause the first material and the second, adhesive material to be drawn from the at least one extrusion element toward the substrate, and form a first plurality of fibers from the first material and a second plurality of adhesive fibers from the second, adhesive material, and
wherein a basis weight of the second plurality of adhesive fibers is about equal to or less than a basis weight of the first plurality of fibers.

19. The electrospray system of claim 18, wherein the at least one extrusion element is configured to deliver a third material on the second plurality of adhesive fibers, such that the second plurality of adhesive fibers is positioned between the first plurality of fibers and the third material.

20. The electrospray system of claim 18, wherein the at least one extrusion element is configured to deliver a third material directly on the substrate, such that the second plurality of adhesive fibers is positioned between the third material and the first plurality of fibers.

21. The electrospray system of claim 19, wherein the third material comprises a non-woven structure.

22. The electrospray system of claim 18, wherein the at least one extrusion element comprises a nozzle comprising:
a first end in fluid communication with a source of the first material and a source of the second, adhesive material, and
a second end from which the first material and the second, adhesive material are each drawn toward the substrate.

23. The electrospray system of claim 22, comprising a plurality of the nozzles.

24. The electrospray system of claim 18, comprising a solution dipping system comprising a plurality of the extrusion elements, wherein the solution dipping system is in contact with a source of the first material and a source of the second, adhesive material, wherein the first material and the second, adhesive material are each drawn from the plurality of extrusion elements of the solution dipping system toward the conductive substrate.
